(19) United States
(12) Patent Application Publication
(10) Pub. No.: US 2023/0381671 A1
(43) Pub. Date: Nov. 30, 2023

(54) SYSTEM FOR AND METHOD OF GENERATING AND DIGITIZING AN IDENTITY

(71) Applicant: Numair Qureshi, Boothwyn, PA (US)

(72) Inventor: Numair Qureshi, Boothwyn, PA (US)

(21) Appl. No.: 18/202,068

(22) Filed: May 25, 2023

Related U.S. Application Data
(60) Provisional application No. 63/346,139, filed on May 26, 2022.

(51) Int. Cl. A63F 13/825; G06T 19/00; G06T 13/40

(52) U.S. Cl. CPC A63F 13/825; G06T 19/006; G06T 13/40

(57) ABSTRACT

Systems, methods, and non-transitory computer-readable storage media for generating and digitizing user identity. A system can assign to a first user a user identification (ID), and receive from the first user at least one user identity selection having a ranked order. The system can then generate, for each identity selection within the at least one user identity selection, a identity ID, and combine the user ID and the identity ID to form a user identity of the first user. The system can then receive, from the first user, a selection of a second user, and the system can compare the user identity to another identity of the second user, resulting in a comparison. The system can then display the comparison.

### CROSS-REFERENCE TO RELATED APPLICATIONS

The present application claims priority to U.S. provisional patent application No. 63/346,139, filed May 26, 2022, the contents of which are incorporated herein in their entirety.

### BACKGROUND

### 1. Technical Field

The invention relates generally to a visual system for generating and digitizing user identity.

### 2. Introduction

Identity characterization, such as personality tests, can be used to characterize an individual's motivations, preferences, interests, emotional make-up, and/or style of interacting with people and situations.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: assigning to a first user, via at least one processor of a computer system, a user identification (ID); receiving, at the computer system from the first user, at least one user identity selection having a ranked order; generating, via the at least one processor for each personality selection within the at least one user identity selection, and identity ID; combining, via the at least one processor, the user ID and the identity ID to form a user identity of the first user; receiving, at the computer system from the first user, a selection of a second user; comparing, via the at least one processor, the user identity to another identity of the second user, resulting in a comparison; and displaying, via a display of the computer system, the comparison.

A system configured to perform the concepts disclosed herein can include: at least one processor; a display; and a non-transitory computer-readable storage medium having instructions stored which, when executed by the at least one processor, cause the at least one processor to perform operations comprising: assigning to a first user a user identification (ID); receiving, from the first user, at least one user personality selection having a ranked order; generating, for each identity selection within the at least one user identity selection, and identity ID; combining the user ID and the identity ID to form a user identity of the first user; receiving, from the first user, a selection of a second user; comparing the user identity to another identity of the second user, resulting in a comparison; and displaying, via the display, the comparison.

A non-transitory computer-readable storage medium configured as disclosed herein can have instructions stored which, when executed by at least one processor, cause the at least one processor to perform operations which include: assigning to a first user a user identification (ID); receiving, from the first user, at least one user identity selection having a ranked order; generating, for each identity selection within the at least one user identity selection, identity ID; combining the user ID and the identity ID to form a user identity of the first user; receiving, from the first user, a selection of a second user; comparing the user identity to another identity of the second user, resulting in a comparison; and displaying, via the display, the comparison.

### BRIEF DESCRIPTION OF THE DRAWINGS

FIG. 1 illustrates an example of an unlabeled four-celled identity diagram;

FIG. 2 illustrates an example array of selectable “Heroes” users can select from;

FIG. 3 illustrates an example process through which users can assign their selected Heroes an order of importance;

FIG. 4 illustrates an example of four Temperament archetypes that can be assigned to each Hero;

FIG. 5 illustrates an example of a user's selected Heroes shown next to their assigned Temperaments;

FIG. 6 illustrates an example array of selectable “Intelligences” users can select from;

FIG. 7 illustrates an example process through which users can assign their selected Intelligences an order of importance;

FIG. 8 illustrates an example of a user's selected Intelligences in their rank order;

FIG. 9 illustrates an example array of selectable “Talents” users can select from;

FIG. 10 illustrates an example process through which users can assign their selected Talents an order of importance;

FIG. 11 illustrates an example of a user's selected Talents in their rank order;

FIG. 12 illustrates an example of four Modality archetypes that can be assigned to each Talent;

FIG. 13 illustrates an example of a user's selected Talents shown next to their assigned Modalities;

FIG. 14 illustrates an example array of selectable “Collections” users can select from;

FIG. 15 illustrates an example process through which users can assign their selected Collections an order of importance;

FIG. 16 illustrates an example of four Modality archetypes that can be assigned to each Collection;

FIG. 17 illustrates an example of a user's selected Collections shown next to their assigned Modalities;

FIG. 18 illustrates an example of a user's finished identity structure, with a button that allows the user to expand the results;

FIG. 19 illustrates an example expansion of a finished identity structure once the expansion button is tapped;

FIG. 20 illustrates an example of a user's selected Heroes with accompanying Temperaments;

FIG. 21 illustrates an example of a user's selected Intelligences;

FIG. 22 illustrates an example of a user's selected Talents and accompanying Modalities;

FIG. 23 illustrates an example of a user's selected Collections and accompanying Modalities;

FIG. 24 illustrates an example computational process for generating an identity structure; and

FIG. 25 illustrates an example computer system embodiment.

### DETAILED DESCRIPTION

Various embodiments of the disclosure are described in detail below. While specific implementations are described, this is done for illustration purposes only. Other components and configurations may be used without parting from the spirit and scope of the disclosure.

The present invention is directed to a visual system for generating and digitizing Identity.

Previous solutions to generate a characterization of one's personality, such as personality tests, attempt to have users answer a series of questions that take a long time to get through, and this makes it difficult for a large number of people to reliably go through the assessment completely. Furthermore, these solutions are not designed to be visually oriented, and may have confusing letters, combinations, or other factors which make their interpretation difficult. Therefore, it can be difficult to use the answers to the questions to digitize an identity. Many solutions are also designed to have users individually characterize a person's identity without providing the users with the ability to measure the match percentage between your identity and another person's identity.

Many existing solutions are available through private psychometric testing procedures. However, they are not designed to be publicly accessible, and therefore they are unable to meet the needs of an industry that requires massive social adoption. These psychometric evaluations are designed to be more privatized, which makes it difficult for people to connect with each other publicly, virtually, or digitally at the level of identity. Furthermore, because many of these existing solutions aren't designed around a visual framework, it is difficult for these solutions to be tokenized via non-fungible tokens (NFT's) that users can purchase so that they may achieve a level of ownership over their identity, and this makes such solutions unable to meet the needs of an industry that is shifting towards ever increasing Internet use and the Metaverse. Furthermore, many of these existing solutions are not designed to help the user share identity on external platforms where people may discover it, and this fails to meet the needs of an industry that wants to bring the world together.

Moreover, many existing solutions lack a mathematical computational component that quantifies identity in such a way that it may be compared to another person's identity which results in a match score. Likewise, many of these existing solutions do not provide a unique identifier string that represents the identity of the individual in the backend; since other solutions lack this, it makes it difficult for the Identities that users generate with their systems to be localized to themselves. Such existing solutions are also not designed to be linked to the blockchain, such that these solutions are unable to meet the needs of the industry because the future is headed towards blockchain technology. In addition, many of these solutions are not designed to help people facilitate financial transactions between users after they discover each other at the level of identity, such that these existing solutions are unable to meet the needs of the industry because people are aiming for individual autonomy over their financial futures.

Many of these existing solutions are not designed for digital interfaces, so they fail to meet the needs of the industry where everything is becoming digital. For example, many of these solutions are not structured in such a way where they may be able to help provide visual identity characterizations in augmented reality, virtual reality, experiential reality, the World Wide Web, and public/actual reality at an interpersonal level. Furthermore, many of these existing solutions are not structured around a universal design language, and therefore fail to meet the needs of an industry where it is essential to bring the world together according to a universal identity language that is accessible to all. Likewise, many existing solutions are not structured in such a way that they are licensable to other platforms, such that people within those platforms may also connect at the level of identity.

Systems and methods configured as described herein allow users to visualize, construct, and integrate their personal identity into virtual and digital spaces, then enable users to discover similarities and relationships between their identity and the Identities. For example, users can first define their identity using the methods and systems described below. Then the users can, within a virtual environment, identify others that have similar Identities, Identities that are compatible with their own, etc. For example, users can insert themselves into a digital environment. In some cases, this can be uploading the identity to a digital platform. In other cases, the user can use virtual reality (VR) headsets that allow the users to digitally view and change their environment. These users can then discover other users within the digital environment. These other users have also gone through the process of generating their own identity. Within the digital environments, users can discover other people who have also generated their identity using the same software. For example, if in a VR environment where the users have digital avatars and can move about a common area, the identity profile (hereafter referred to as “Identity”) of each user can be digitally placed above the user's avatar, such that others viewing the user's avatar within the common area can see (1) the “body” of the avatar, with (2) the user's Identity immediately above the avatar. As the avatar moves about the common space, the Identity moves with the avatar. If the user leaves the common area, or closes the VR experience, such that the avatar disappears from the common area, the Identity will likewise disappear from the common area. The Identity can also be appended to other virtual software experiences using an API (Application Programming Interface) integration.

Consider the following example. The system can grant other applications access to using the identity-building methods disclosed herein within their own environments. If, for example, an application (“App”) has a virtual experience which it provides to its clients, and the clients of that App want to also have their own visual identities, as disclosed herein. The App can request API access to the system disclosed herein, allowing the App's users to build their own Identity using the disclosed system, and then the user's visual identity can appear above their avatars within that specific VR experience. If the users of that App already have credentials by using the disclosed system, then they can connect their already-established identity to the new App experience. This is similar to the universal FACEBOOK login, where when you sign into certain Apps you can use the same login as one uses for FACEBOOK. Here, if users already have a visual identity that they have generated, other Apps can access the system, allowing the user to use their already-generated visual identity. If the user had not already generated a visual identity using the disclosed system, they can be prompted to create an account, at which point they can create a visual identity for usage in the other App.

Preferably, the systems and methods described herein can be implemented as an application on mobile devices so that people can access the system and software more easily and globally. The systems and methods described herein allow users to discover other like-minded people using the identity algorithm. For example, when using the system, the users can view a Discovery Feed built into the application, where users can interact with others who have their own Identity. Users can see the Identity of these other users, and they can compare their identity with others to see a percent match score. If, for example, the user sees another user identity/avatar with whom they want to interact, the user can then initiate an Identity comparison. Based on that comparison, additional interactions may take place. For example, if that comparison meets a minimum threshold of compatibility, the user may initiate further interactions. If the comparison does not meet that minimum threshold of compatibility, the system may send a warning or other notification to one or both parties indicating that the two users have a below-threshold likelihood of compatibility. In some cases, the Identities may be too similar, which may also trigger compatibility issues.

In some configurations, the system may enable users to create non-fungible tokens (NFT's) using their Identities, thus giving these users the ability to have various forms of ownership over their Identities. NFT's created using the disclosed system are different from other NFT's in that the users first must go through the identity engine process described below to craft their own Identity before they can mint an NFT using it. These NFTs contain a specific type of data—namely a user's Identity—thereby distinguishing it from other types of NFTs. It is that user-generated action that enables the minting of that NFT. Whereas other NFT's are generated as the result of tokenizing user-generated art, NFT's generated using the system described herein use an individual's particular Identity formed via the processes described below.

In some configurations, the system can allow users to share their digital Identities to external platforms. For example, the system can provide options to share their Identities to desired platforms. Such platforms may include LINKEDIN, INSTAGRAM, FACEBOOK, TWITTER, and/or other social media platforms. The user's identity can then be presented as a post within that platform, and the users can write a description surrounding the Identity.

In some configurations the system may be licensed to other platforms so that the users within those other platforms may also connect at the level of identity, compare their identity with others, and discover new connections based on their Identity. Previous personality systems were not designed for interpersonal connection, but rather to describe one's one behavior or world-view by facilitating introspection and deeper self-understanding. The system described herein can provide users with a way to discover and connect at the level of identity itself, something that is technically different from other known connection systems. Whereas most social media recommendations for new contacts are based on a social graph of the users (e.g., known relationships), the system disclosed herein can allow users to connect with others based on their Identity and the Identities of others. In other words, rather than presenting possible connections based on other relationships, possible connections can be presented based on Identity compatibility. For example, the disclosed system and associated software can provide a process through which users may visualize, construct, and digitize their Identity by identifying their Heroes and associated Temperaments, Intelligences, Talents and associated Modalities, and Collections and associated Modalities, and then integrate that Identity into the World Wide Web.

In some configurations, the system can offer results reports to people and businesses. For example, the system can be used to help companies hire the right employees. The system can also be used for matchmaking, for data analytics, for predicting trends in the financial markets when such trends are aligned with identity influences, etc. For example, the system can access users' unique identifier strings as they exist within other platforms through API or through online activity that they partake in while logged into the system. The system can then analyze behaviors the user performs online, and the system can connect these behaviors to the user's unique identifier strings in accordance with their Identity. Predicting trends in financial and stock markets can be done by analyzing how emotions and social events heavily influence the stock market. For example, the system can analyze the Identities of constituents that are supporting a specific financial or stock movement, then predict how such structures may change in the future based on the Identities that support those structures.

Likewise, the disclosed system can also provide an identity structure architecture which can be used to animate Artificial Intelligence (AI) engines. For example, an AI system can include Identity structures as defined herein, and the system can deploy Identity to animate these Artificial Intelligence Identities according to themes surrounding Heroes, Intelligences, Talents, & Collections (specific pieces of the Identity as described below). Therefore, such AI is programmed with Identities that emulate specific “Heroes” known to mankind, are programmed to have a dominant intelligence structure out of the nine available according to Howard Gardner's “Theory of Multiple Intelligences.” The AI is also programmed with certain innate “talents” that other AI do not possess.

For example, the AI can use a list of pre-made talents. The AI Software can select talents from the list of pre-made talents as it constructs the avatar. Those talents are programmed within the software itself, and it can continue to be updated as more talents are made known. Computationally, the AI software can use the identity creation concepts disclosed herein to randomly create AI avatars that best resemble a query. For example, if someone wants to construct an identity avatar resembling Dr. Martin Luther King Jr., then the AI software, via an API, can use the disclosed system to generate an avatar that resembles Dr. Martin Luther King Jr.'s identity as closely as possible using the available Heroes, Intelligences, Talents, and Collections choices. The selection of these choices may be random and subjective as per the perception of the AI requesting access to the system's API. For example, if ChatGPT wishes to integrate their algorithm with the system, the ChatGPT Linguistic Model may have a different perception of who Dr. Martin Luther King Jr. was, and that perception will influence the way that software uses the disclosed algorithm to generate the identity of Dr. Martin Luther King Jr. Therefore, when AI is accessing the disclosed system, it is strictly accessing the disclosed algorithm. Such AI software relies on its own intelligence and code to influence the decisions that are made in terms of creating an Identity for its avatar using the system. This also applies to AI in instances where there is user-involvement. As with the case of ChatGPT, there may be an instantaneous result based on the understanding of the AI Software; however, once the result has been arrived at, then the end user (a human) may be granted the ability to further modify the identity of that avatar. As with the case of organizations and entities, this may be a person who has authorized access to such modifications. In some configurations, civilian (e.g., not an organization or entity, or someone without such authorization) access to modifications may also be granted as well on a per case basis.

The resulting AI avatars can also “live” inside spaces that complement their identity by having those spaces be decorated as such to express important collections belonging to such Artificial Intelligence. In configurations where the AI can take on the form of an avatar, users may be given the ability to design such avatars and animate the AI Identities according to the structure(s) of the system.

When it comes to matchmaking, the system disclosed herein can be used within the structures of existing dating apps and social networks that are designed to bring people together. For example, the system can provide an integration into such platforms and apps so that their existing users can discover new connections all based on identity alignment. In this case, the system can exist as an API in the other platforms. For example, when a user uses a dating application they can also log in with their Identity, allowing their Identity to be part of the dating app experience. This can apply to social networks as well. When platforms need a way for people to integrate their Identity within those platforms, this can be facilitated via a login button. If users do not have an Identity account, then they can create one going through the account creation process. Once an Identity has been generated, then the users can be redirected back to the platform they had left. Users within those platforms can integrate their digital identity into those platforms if they already have an account with the system; or, if they do not have an account with the system, then the users can be directed to go through an onboarding process so that they can generate their own Identity, and then they would be redirected to the platform they left.

The system disclosed herein can be used by employers to search for and attempt to hire the right people for their teams. In some configurations, the data can be accumulated so that it may be modeled and sold to other agencies. Likewise, in some configurations the system can be used to help other agencies achieve better clientele by using Identity data sets to identify clientele that fit with a desired identity structure. In addition, in some configurations the disclosed identity structure architecture can be built into a social media application and environment, where many users can sign up and engage with each other at the level of identity. In such configurations, the system can provide the ability to discover other users at the level of identity and then schedule time with each other so that they may transact with each other.

The system disclosed herein can be, for example, made available on desktops, laptops, mobile phones, and other computational devices of the sort. The system can include the following exemplary, non-limiting components: An assessment consisting of different screens that allow the user to construct an Identity based on Heroes, Hero Temperaments, Intelligences, Talents, Talent Modalities, Collections, and Collection Modalities. The Temperaments and Modalities can be color-coded.

These components can be related and connected as follows: As people go through the assessment, they can choose their four primary Heroes, four primary Intelligences, four primary Talents, and four primary Collections. The selection of the Intelligences yields the Talents available to be selected by the user on the following screen. The Heroes are linked to a Temperament, and the Talents and Collections are linked to a modality. All this results in a four-celled visual badge in which the first cell represents Heroes and Hero Temperaments of the user. The primary hero choice is made visible within the first cell. The secondary, tertiary, and quaternary Hero choices are layered beneath the primary Hero, and they are invisible to the user until the user expands their full identity results. The borders of the first cell are filled with the colors that represent the Temperaments of the Heroes in order of importance. All these colors are visible even though the underlying Heroes are not, unless these Heroes are expanded. The Temperament color at the top left corner of the first cell represents the Temperament of the first Hero. The Temperament color at the top right corner of the first cell represents the Temperament of the second Hero. The temperament color at the bottom left corner of the first cell represents the Temperament of third Hero. The Temperament color at the bottom right corner of the first cell represents the Temperament of the fourth Hero. The Intelligence selections are also color-coded. The second cell represents Intelligences of the user, and the primary Intelligence is made visible. The second, third, and fourth Intelligence choices are layered beneath the primary. The corners of the second cell represent the Intelligence choices, with the primary Intelligence color being represented by the top left colored corner. The top right colored corner of the second cell represents the secondary Intelligence selection; the bottom left colored corner of the second cell represents the third Intelligence selection, and the bottom right colored corner of the second cell represents the fourth Intelligence selection. The third cell represents the Talent choices, with the primary Talent made visible. Similar to the first and second cells, the second, third, and fourth Talents are layered beneath the primary Talent. The colored corners represent the Modalities linked to each Talent, and they follow the same process as the Temperaments that are linked to the Heroes in the first cell. The fourth cell represents Collection choices, with the primary Collection choice made visible. The fourth cell functions similarly to the behaviors manifest in the first and third cells.

The associated computer process is made up of the following executable steps, all of which are required in all versions: First, the user identifies four primary Heroes out of nine available Heroes. The user ranks them in order of importance, with (1) being the most important out of the nine available selections and (4) being the fourth most important out of the nine available. In the future, there may be more Hero selections, but the current iteration of the application only has nine. Next, the user assigns a King, Warrior, Magician, or Lover Temperament to each Hero. These Temperaments are color-coded. The next screen shows a summary of the Heroes and associated Temperaments selected. The next screen moves you onto the selection of Intelligences. Here, the user chooses four out of nine primary Intelligences made available. In the future, more Intelligence selections may be provided. The user ranks the order of the four Intelligences in order of importance again, with (1) being the most important of the nine options. The next screen shows the summary of the four Intelligences selected in order of rank. The Intelligences chosen triggers the Talent choices made available on the next screen. Altogether, the entire system currently has 36 available Talents to choose from; however, only sixteen are shown; in the future, more Talent choices may be made available. Since four Intelligences were chosen in the previous screen, the Talents screen shows four different types of Talents that align with each Intelligence chosen. After Talents are rank ordered, the user assigns a Modality to each Talent. The Modalities consist of Physical, Spiritual, Logical, and Creative characteristics. The next screen shows the talents and their respective Modalities ranked in order of importance to the user. The final section of the assessment presents nine available Collections, of which four are chosen and rank ordered in order of importance. In the future, more Collection choices may be made available. Then, the user links a Physical, Spiritual, Logical, or Creative Modality to each Collection. The user may choose the same Modality for each Collection, and may choose a different Modality for each Collection, though repetition of Modality assignment is allowed. The same logic applies to heroes and their Temperaments and Talents and their Modalities. Once the user gets past the Collections Modality selection screen, they see a results summary of the rank order of all four Collection choices and their associated modalities. Finally, the user is shown a results screen that depicts the user's entire four-celled identity with all its primary Hero, primary Intelligence, primary Talent, and primary Collection made visible in the first, second, third, and fourth cells respectively; furthermore, each cell displays its colored borders as well. The user may see an expanded view of this identity badge by tapping a button that shows all the choices made during the assessment. After this, the user may complete their profile.

As a user goes through each section of the assessment, there is a weighted score generated in the backend by the software. Furthermore, all the choices are computed and strung together in a unique identifier that is linked directly to the user who has undergone the construction of said identity. This identifier consists of the User ID, Hero ID, Temperament ID, Intelligence ID, Talent ID, Talent Modality ID, Collection ID, and Collection Modality ID. This unique identifier allows the system to compare the identity of one user to another user, and it also allows the user to eventually preserve an NFT linked to that identity.

The system may also have one or more of the following optional components: The ability to show a user's identity within a smart watch, the ability to use the identity within virtual reality, augmented reality, and experiential reality, users can then integrate their identity on external social media platforms and channels; in the future, additional Heroes, Hero Temperaments, Intelligences, Talents, Talent Modalities, Collections, and Collection Modalities may be added to the system; the system, through its unique identifier, may also be included into the structure of the blockchains of cryptocurrencies, the system may also provide users with the ability to transact with others using cryptocurrencies. By incorporating the unique identifier string into a blockchain, the system provides the foundational structure for tokenizing an identity into an NFT. The way a blockchain works is that it acts as a public ledger with copies across multiple locations called nodes, which usually refer to individual computers with copies of the ledger. Instead of any one particular person or computer holding this information, the information is spread across multiple nodes that make up the network. This way, if one of the nodes fails, there are still copies existing across the rest of the nodes that comprise the network. In this case, by incorporating the unique identifier into a blockchain, the system creates a decentralized Identity, which allows the creation of NFT's, and allows the Identity to be verified in a decentralized manner. As such, when users transact with each other within the system using cryptocurrencies, the unique identifiers of the users can be linked to the cryptocurrencies being transacted, thus creating a safer system of financial accountability and monitoring.

In some configurations, the system can also include the ability for users to connect their Identities to external platforms for use within those platforms. For example, the system may be integrated into financial trading systems for the prediction and analytics of stocks and investments. In some cases, system data may be incorporated by financial institutions for the understanding and modeling of their own existing client-base. For example, a major financial institution may have clients that invest money into that very institution. That institution can provide the system access to data that represents their top clientele (e.g., the top ten percent), and the system can model the Identities of the top clientele to discover similar Identities within the system's existing database. Using such data, the system can provide the financial institution with new potential client contacts. The system can also analyze the unique identifier strings behind clients who have invested in certain stocks to determine what kinds of identity trends exist behind the purchase of such stocks. Such analysis can, for example, be a longitudinal analysis that follows individuals/clients/users over time.

The system may also be configured to be integrated into the consulting industry where employers may hire job candidates based on a generated Identity. Likewise, the system may be integrated within dating applications to offer matches. The system may also be integrated within tokenized economies where the sale of these digital Identity units may be rendered for people seeking to collect and exchange Identities. This is different than the sale of traditional NFT's that cannot be replicated because, in order to mint an NFT using a unique identifier string as disclosed herein the user must first go through a psychological assessment that helps establish the Identity based on heroes, intelligences, talents, and collection, as disclosed herein.

In some configurations the system may be used for psychological applications of therapy, counseling, coaching, and mental health. The system may also be integrated into identification tags that people wear throughout the world, such that those individuals may be identified by the Identity generated by the system. Similarly, the system may be integrated with financial transaction software so that as payments are sent and received between users, the transactions are legered within the unique identifier strings based on the user's Identity, which are then connected to the blockchain ledger. Preferably, the blockchain used by the system allows for the ledgering of an item using a random new unique identifier string profile. The system, using this blockchain, can also allow for cryptocurrency transactions to be coupled with such Identities. If needed, the cryptocurrencies may be unique to the system, which means the system can mint a new cryptocurrency using blockchain for use with the Identity-based transactions.

The system may also have one or more of the following optional executable steps: The ability to search for a specific type of Hero, Temperament, Talent, Talent Modality, Collection, or Collection Modality; the ability to search for people based on identity configurations; the ability to set up advertising campaigns that target intended Identity configurations.

Furthermore, the system may also have gamification features that provide a score for user actions taken within the system and software. This is a way to help stimulate repeat use of the system and software.

Furthermore, the system may also provide (via a display) a button called Spark that, once clicked or tapped, enables the users to unlock features that give greater access to communicating with a desired user.

Furthermore, the system may also provide the ability for users to transact with each other and schedule time to communicate with each other, such that both parties can discover each other at the level of identity.

Furthermore, the system may also provide a dashboard through which people may be able to map out their changes in identity over time as they go through the identity structure assessment repeatedly.

The disclosed system is unique when compared with other known systems and solutions in that it provides users with a visual interface that enables them to build their own identity consisting of their Heroes, Hero Temperaments, Intelligences, Talents, Talent Modalities, Collections, and Collection Modalities. This system has a backend that tabulates a unique identifier string for the participants as they go through the identity construction assessment. The identity system itself uses symbols and colors to help provide a structure to interpreting nuance in an identity. The ability for users to match their Identities with other users and share their results while also being able to express their own Identities on external platforms creates a viral mechanism through which viral growth may be instantiated within the platform. Similarly, the system disclosed is unique when compared with other known solutions in that it provides users with the ability to use their identity in such a way that they can see how it matches with other Identities, they can share their identity to external platforms, they can see an expanded view of their identity as well as others' Identities, they can mint NFT's of their Identities, they can link their Identities to the blockchain, they can transact using cryptocurrencies and those transactions become linked to their Identities. The disclosed system can help connect people at the level of identity, and it can be licensed to additional platforms so that the users within those platforms may also connect at the level of identity. The unique functions of the system make it so that people all over the world can connect at the level of identity. The disclosed system provides:

A visual method of guiding users to construct their own identity consisting of their Heroes, Hero Temperaments, Intelligences, Talents, Talent Modalities, Collections, and Collection Modalities.

The ability to display that identity visually across the web, including social media platforms, and also within our native app. When people come across this identity, they are able to expand it to see what makes it up.

The ability to match with other Identities as the user comes across them.

A visual method of guiding users into constructing their own identity consisting of their Heroes, Hero Temperaments, Intelligences, Talents, Talent Modalities, Collections, and Collection Modalities such that the users go through a series of interfaces that help them to construct said identity, as follows:
1. The Heroes screen has nine hero possibilities, inspired by Carl Jung's work on archetypes, with more to potentially be added in the future. Users are invited to select four and rank order them. Here is the list of Heroes:
2. Actor
3. Athlete
4. Designer
5. Leader
6. Musician
7. Naturalist
8. Philosopher
9. Scientist
10. Self-Reflector
11. The Heroes screen is followed by a Heroes Temperament screen, which is designed to help assign a Temperament to the four primary Heroes chosen on the Heroes screen. These Temperaments were inspired by Douglas Gilette and Robert Moore's work, and they are known as:
12. King/Queen
13. Warrior
14. Magician
15. Lover
16. The Temperaments show up as colors within the corners of the Heroes cell.
17. The Heroes within the Heroes Cell are layered such that the primary hero is visible, and the rest are made visible once this cell is expanded.
18. The Intelligences screen has the following nine Intelligences, based on Howard Gardner's Theory of Multiple Intelligences, of which four are selected and rank ordered:
19. Verbal-Linguistic
20. Naturalistic
21. Logical-Mathematical
22. Bodily-Kinesthetic
23. Intrapersonal
24. Musical
25. Visual-Spatial
26. Existential
27. The Intelligences appear as colors in the corners of the Intelligences cell.
28. The Intelligences within the Intelligences cell are layered such that the primary Intelligence is visible, and the rest are made visible once this cell is expanded.
29. The way the Talents screen appears is based on the four Intelligences chosen on the Intelligences screen. There are 36 total Talents available, but more could be made available in the future. Only sixteen talents are shown, with four Talents linked to each of the four Intelligences chosen on the previous screen. Users are invited to rank order their four primary Talents. The available Talents are:
30. Talent
31. Acting
32. Speaking
33. Debating
34. Writing
35. Math
36. Science
37. Puzzles
38. Coding
39. Singing
40. Playing Music
41. Producing
42. Songwriting
43. Observing
44. Cooking
45. Navigation
46. Ecology
47. Athletics
48. Combat
49. Tools
50. Hunting
51. Fashion/Style
52. Design
53. Photo/Video
54. Building
55. Gaming
56. Socializing
57. Leadership
58. Counseling
59. Journaling
60. Reading
61. Planning
62. Thinking
63. Intuition
64. Synchronicity
65. Meditation
66. Peace
67. The Talents are followed by a Talent Modalities screen that helps identify the Talent as it is aligned with any of the following choices:
68. Physical
69. Spiritual
70. Logical
71. Creative
72. The Talent Modalities are colored, and they fill the corners of the Talent cell.
73. The Talents within the Talent Modalities cell are layered such that the primary Talent is visible, and the rest are made visible once this cell is expanded.
74. Next, the users are guided into selecting their meaningful collections. As of now, there are only nine choices; however, there may be more choices in the future. These nine Collections are:
75. Social Activities
76. Music
77. Heirlooms
78. Fitness
79. Aesthetics
80. Nature
81. Technology
82. Theatrical
83. Self-Improvement
84. Users are asked to choose four of the nine collections and rank them in order of importance, as described earlier. Then they are invited to attribute Collection Modalities to them. These Collection Modalities may be assigned in any number of ways, and repeats are allowed; however, only one modality is to be assigned per collection.
85. Physical
86. Spiritual
87. Logical
88. Creative
89. These Modalities are also color coded, and they fill the corners of the collections cell.
90. The Collections within the Collections cell are layered such that the primary Collection is visible, and the rest are made visible once this cell is expanded.
91. All these sections combine to create the resulting Identity.

On the backend of the identity construction is a database that creates a unique identifier string, which may be learned about in fuller detail above.

Users are able to share their identity to external platforms if desired.

Users are also able to match with other users by tapping on a button (displayed on a display) that enables them to match Identities. When they do this, the Identities can be displayed side-by-side, both Identities can be expanded, and there can be a match percentage shown between both Identities.

The backend software (i.e., the software executed by cloud-based servers which executes various computations, compared to the frontend software which users can directly interact with) can also calculate a matrix of match results between many users.

Preferably, the system is made up of the following components: A registration screen, an assessment that can navigated through on computing and mobile devices, a unique identifier code, a matching system, a profile creation system, and a discovery feed. The unique identifier can be built as the user goes through the entire onboarding process, which begins when an account is created at the initial sign-up screen. The structure of the unique identifier can be:
User ID: Hero ID: Hero Temperaments ID: Intelligences ID: Talents ID: Talent
Modalities ID: Collections ID: Collections Modalities ID

The User ID is the number assigned to a registrant in order of registration. For example, if there are one thousand users on the platform, and a new registrant appears, then the User ID of that registrant is 1001. The rest of the unique identifier structure will be discussed with respect to the various aspects of the assessment.

The assessment consists of the following screens, elements, and functions:
Heroes
   Heroes Temperaments
Intelligences
Talents
   Talent Modalities
Collections
   Collection Modalities
The resulting Unique Identifier
The ability to match Identities between users

These components are combined together to create an architecture for the system that yields a visual and digital identity for the end user.

Heroes is the first screen that appears in the assessment. The users see nine different choices for their heroes, and they pick the four that are most important and/or relevant to them. The nine exemplary choices are:
Actor: someone who performs in movies, plays, or on television.
Athlete: someone who engaged in athletic performance such as, but not limited to, martial arts, ballet, swimming, and football.
Designer: someone who captures creative and/or abstract ideas in meaningful ways.
Leader: someone who helps people align with one common, collective, vision, and examples of leads include, but are not limited to, civil rights leaders, sports captains, generals, and government officials.
Musician: someone who expresses sound in creative and orchestrated ways in order to share a message.
Naturalist: these are people driven by nature. They can be, but are not limited to being, biologists, outdoorsmen, gardeners, environmentalists, and botanists.
Philosopher: probes into the relationship between human nature and existence. Examples include, but are not limited to, Plato, Socrates, Aristotle, Ayn Rand, and John Locke.
Scientist: generally concerned with codifying nature so that his or her discoveries may be replicated and reproduced. Examples of scientists include, but are not limited to being, geneticist, mathematicians, researchers, and medical doctors.
Self-Reflector: those who like to observe the world silently, and they tend to be, but are not exclusive to being, writers, poets, and journalists.

Definitions are provided for each hero, and users are asked to select the four heroes who are most important to them in order of importance of the nine available. Assigning a rank order of 1 indicates that this hero is the most important, whereas assigning a rank order of 4 indicates that this hero is of fourth order importance of the four selected.

The user may change the rank by tapping on the selected hero again and then reselecting the hero in the correct order of importance. Once the heroes have been ranked, the user then taps on the next button.

Each Hero is assigned to an identification number in the backend, which is not visible to the end user. These numbers are as follows:
Actor: 1
Leader: 2
Philosopher: 3
Athlete: 4
Musician: 5
Scientist: 6
Designer: 7
Naturalist: 8
Self-Reflector: 9

As the user selects four heroes and ranks them in order of importance, the schema is captured in the database and a HERO ID is added to the unique identifier string immediately after the USER ID. For example, if the four heroes, ranked in order of importance, are Designer, Philosopher, Musician, and Naturalist, then the HERO ID becomes: 7358, in which 7 represents the Designer, 3 represents the Philosopher, 5 represents the Musician, and 8 represents the Naturalist.

As such, the unique identifier string builds to: USER ID:HERO ID.

If this is the 1001^{st} user to sign up, then the unique identifier string becomes: 1001:7358

Next, the user is asked to assign a temperament to each hero. Here, the user is presented with four archetypes which serve is potential temperaments for each hero: King/Queen, Warrior, Magician, and Lover. Definitions are provided for each temperament.
King/Queen: a person who acts largely through leadership and vision.
Warrior: a person who singlehandedly gets the job done
Magician: a person who acts largely through mental work.
Lover: someone compassionate who acts largely through creative work.

The ranked heroes from the previous section are presented once again on this section of the test, with the primary hero (rank 1) shown first. The user is asked to assign a King, Warrior, Magician, or Lover temperament to this hero. In the backend database, an ID Is generated for this temperament selection, and then this ID is added to the unique identifier string. The database ID numbers for the temperaments are:
King/Queen: 1
Warrior: 2
Magician: 3
Lover: 4

Each temperament has its own color, and this color shows up in the corner of the Hero Cell in the completed identity. The Hero cell is the first cell in the four-celled identity symbol. The top left corner of the Hero Cell carries the color of the first temperament. The top right corner of the Hero cell carries the color of the second temperament. The bottom left corner of the Hero cell carries the color of the third temperament. The bottom right corner of the Hero cell carries the color of the fourth temperament.

The user assigns these temperaments to the second, third, and fourth Hero choices as well. The temperaments can be repeated if so desired. For example, if users desired to choose Warrior for all their heroes, they may. Consider if it is decided that the following four heroes receive the following temperament assignments:
Designer: Warrior
Philosopher: Warrior
Musician: Magician
Naturalist: King/Queen

In this case, the Temperament ID would consist of Warrior (2), Warrior (2), Magician (3), and King/Queen (1); in other words, the Temperament ID would be 2231.

The resulting unique id string would be: 1001:7358:2231, representing USER ID:HERO ID:TEMPERAMENT ID

The next screen that appears in the process is Intelligences. Here, the users are presented with nine intelligences, and each intelligence has its own color. The colors are subject to change as the system goes through updates. For now, it is just important to know that the color of an intelligence represents that intelligence itself. Here are the nine intelligences along with their definitions and database ID's:

| | | Database |
|---|---|---|
| Intelligence | Definition | ID |
| Verbal-Linguistic | Verbal-Linguistic intelligence is | 1 |
| | expressed in the effective use of language | |
| | through reading, writing, speaking, and | |
| | reading. | |
| Naturalistic | Naturalistic intelligence examines the | 2 |
| | appreciation and classification of | |
| | environmental features and life forms. | |
| Interpersonal | Interpersonal intelligence is expressed by | 3 |
| | those who seek self-understanding. They | |
| | seem to analyze themselves a lot, and | |
| | they like to keep to themselves. | |
| Logical- | Logical-Mathematical intelligence | 4 |
| Mathematical | focuses on making connections between | |
| | sequences and patterns such that they | |
| | may be expressed coherently. | |
| Bodily- | Bodily-Kinesthetic intelligence is the | 5 |
| Kinesthetic | ability to move one's body within in an | |
| | environment in a fine-tuned and | |
| | coordinated manner. | |
| Intrapersonal | Intrapersonal intelligence is the opposite | 6 |
| | of interpersonal, and it is expressed in the | |
| | ability to understand people and bringing | |
| | them together. | |
| Musical | Musical intelligence is expressed in the | 7 |
| | ability to sing, play a musical instrument, | |
| | being able to distinguish tones, rhythms, | |
| | and etc. | |
| Visual-Spatial | Visual-Spatial intelligence is expressed in | 8 |
| | the ability to perceive objects, colors, | |
| | images, shapes, depth, scenes, art, and | |
| | multiple dimensions. | |
| Existential | Existential intelligence is expressed in the | 9 |
| | ability to see patterns in universal themes | |
| | and then bringing them together in a | |
| | simplistic way such that they may | |
| | influence humanity. | |

When these intelligences are selected, they give rise to the colored corners in respect to the order of their selection, as described in the first paragraph of the detailed description. As done previously in other sections, the user will choose four intelligences and rank them in order of importance while the database records the Intelligence ID number in the backend and adds it to the unique identifier string. For example, consider that the following four intelligences are chosen and ranked in order of importance:
1. Musical
2. Existential
3. Intrapersonal
4. Logical-Mathematical

In this case, the Intelligence ID would be: 7964, and the unique identifier string would be 1001:7358:2231:7964, representing USER ID: HERO ID: HERO TEMPERAMENT ID: INTELLIGENCE ID

The colors of the selected Intelligences also fill the corners of the second cell in the same order as the Temperaments filling the corners of the first cell pertaining to hero selection.

The next screen consists of Talent selections. The Intelligences are directly linked to the user's Talents, such that each Intelligence triggers four Talent available to be chosen from and ranked in the Talents section; therefore, all users will have the ability to choose four out of 16 Talents, even though there are 36 total Talents manifest within the system. Here are the 36 Talents as they are linked to their respective Intelligences, along with definitions and the database ID for each Talent:

| | Talent | Associated | |
|---|---|---|---|
| Talent | ID | Intelligence | Definition |
| Acting | 1 | Verbal- | Performance in plays, movies, television shows, |
| | | Linguistic | and etc. |
| Speaking | 2 | Verbal- | Giving speeches, narrating books, doing talk |
| | | Linguistic | shows, giving the forecast, etc. |
| Debating | 3 | Verbal- | Pirates vs. Ninjas, Cowboys vs. Eagles, Winter vs. |
| | | Linguistic | Summer, etc. |
| Writing | 4 | Verbal- | Books, poetry, articles, etc. |
| | | Linguistic | |
| Math | 5 | Logical- | Solving math problems. |
| | | Mathematical | |
| Science | 6 | Logical- | Doing scientific experiments and/or research. |
| | | Mathematical | |
| Puzzles | 7 | Logical- | Figuring out solutions to complex problems of all |
| | | Mathematical | kinds by analyzing patterns and trends. |
| Coding | 8 | Logical- | Being able to express knowledge in abstract ways |
| | | Mathematical | such that it may be used with simplicity. |
| Singing | 9 | Musical | R&B, Rock, Pop, Jazz, Rap, etc. |
| Playing Music | 10 | Musical | Proficiency in using a musical instrument. |
| Producing | 11 | Musical | Proficiency in being able to make compositions. |
| Songwriting | 12 | Musical | Proficiency in being able to write lyrics to catchy |
| | | | songs. |
| Observing | 13 | Naturalistic | Being able to discern information from within the |
| | | | environment. |
| Cooking | 14 | Naturalistic | Being able to make delicious food. |
| Navigation | 15 | Naturalistic | Being able to find one's way out of anything. |
| Ecology | 16 | Naturalistic | Being able to read nature for the clues it may give |
| | | | you, such as moss growing on the north side of |
| | | | trees. |
| Athletics | 17 | Bodily- | Being able to use one's body to perform finely- |
| | | kinesthetic | tuned and coordinated maneuvers in order to reach |
| | | | a goal. |
| Combat | 18 | Bodily- | Being able to defend one's self in hand-to-hand or |
| | | kinesthetic | weapons-aided combat. |
| Tools | 19 | Bodily- | Knowing how to use tools. |
| | | Kinesthetic | |
| Hunting | 20 | Bodily- | Being able to capture game with precision either |
| | | Kinesthetic | for sport or for sustenance. |
| Fashion/Style | 21 | Visual- | Having a great dress sense and/or being able to |
| | | Spatial | trigger trends in style. |
| Design | 22 | Visual- | Being able to put together information in a |
| | | Spatial | visually and functionally pleasing way. |
| Photo/Video | 23 | Visual- | Being able to capture and/or edit great |
| | | Spatial | photographs and videos. |
| Building | 24 | Visual- | Being able to build structures according to |
| | | Spatial | blueprint. |
| Gaming | 25 | Interpersonal | Skill in competitive and solitary games, whether |
| | | | they are video games, card games, or anything |
| | | | inbetween. |
| Socializing | 26 | Interpersonal | Being able to make friends and meaningful |
| | | | relationships with ease. |
| Leadership | 27 | Interpersonal | Being able to bring people together for a common |
| | | | cause. |
| Counseling | 28 | Interpersonal | Being able to understand people enough to help |
| | | | them through their dilemmas. |
| Journaling | 29 | Intrapersonal | Being able to capture one's life's moments and |
| | | | discoveries on paper. |
| Reading | 30 | Intrapersonal | Being able to take in structured, organized, data, |
| | | | regularly either through books, magazines, blogs, |
| | | | and so on. |
| Planning | 31 | Intrapersonal | Being able to declare a goal and ten actively |
| | | | pursuing it towards its completion. |
| Thinking | 32 | Intrapersonal | Being able to reflect on information for extended |
| | | | periods of time. |
| Intuition | 33 | Existential | Being able to interpret the meaning of subtle signs |
| | | | and to address them before they become large |
| | | | occurrences. |
| Synchronicity | 34 | Existential | Being able to trigger events that are in alignment |
| | | | with one's thoughts and energy. |
| Meditation | 35 | Existential | Being able to clear the mind and bring it to |
| | | | stillness such that the user experiences oneness |
| | | | with nature and the cosmos. |
| Peace | 36 | Existential | Being able to bring harmony to chaos. |

Please note that the descriptions have examples of the talents, but the examples are not exclusive. In other words, there may be many other examples that serve these Talents. The Intelligences chosen in the previous section trigger the Talents available in the Talents section. The users are presented within 16 Talents, and they are asked to rank them in order of importance from (1) to (4). Once these four are chosen and ranked, the database captures their Talent ID in the database. For example, if the four chosen talents are, Gaming (25), Peace (36), Planning (31), and Design (22), then the Talent ID is: 25363122.

The resulting unique identifier string, then, is: 1001:7358:2231:7964:25363122.

The next screen has the user go through Talent Modality assignment. This follows the same process as the Hero Temperaments. Again, the four Talents from the previous section are shown here, one by one. Each Talent is then presented with four Modalities:
1. Physical—talent experienced with the body
2. Spiritual—talent experienced with the spirit
3. Logical—talent experienced with the logical mind
4. Creative—talent experienced with the creative mind
   Each modality has its own Modality ID:
Physical—1
Spiritual—2
Logical—3
Creative—4
   Each Modality is then paired with each talent. Modalities can be repeated, as in the case with the Hero Temperaments. In this example, the four Talents are assigned to the following four Modalities:
1. Gaming: Physical
2. Peace: Spiritual
3. Planning: Spiritual
4. Design: Logical
   In this case, the Modality ID would be 1223 (Physical, Spiritual, Spiritual, Logical), and the unique identifier string would be:
1001:7358:2231:7964:25363122:1223

Similar to the Hero Temperaments, the Talent Modalities have their own unique colors as well, and these colors adorn the corners of the third cell in a similar manner to the Hero Temperaments and the Intelligence colors.

The next section would have the user identify collections. These are the things that the user owns that help express who they are. The system collects things that align with the user's identity, and places them into spaces so that the spaces can mirror back who the individuals are at the core. There are nine Collections to choose from on this screen. In the following table are illustrated nine Collections, their Collection ID's, and their descriptions:

| | Collection | |
|---|---|---|
| Collection | ID | Description |
| Social Activities | 1 | Items and activities that bring people together. |
| Music | 2 | Items that let the user experience music, e.g., mp3 players, |
| | | CD's, vinyl records, and musical instruments. |
| Heirlooms | 3 | Items that trigger emotional and sentimental value, e.g., |
| | | love letters, notes, memorabilia, heirlooms, and |
| | | photographs. |
| Fitness | 4 | Items that improve health, fitness, and athletic ability. |
| Aesthetics | 5 | Items that help the user add greater visual structure to the |
| | | world, e.g., clothes, paintbrushes, decor, furniture, art, and |
| | | etc. |
| Nature | 6 | Items that help the user collect and examine nature. |
| Technology | 7 | Gadgets, computers, vehicles, and items that deal with |
| | | innovation and advancement. |
| Theatrical | 8 | Items the user collects that deal with film and/or theater. |
| Self-Improvement | 9 | Items that help the user improve one's self, e.g., books, |
| | | seminars, science, and religion. |

The users select their tour most important and rank them as such. This ranking leads to a Collections ID. For example, if Nature, Theatrical, Aesthetics, and Fitness are chosen, then the Collections ID becomes: 6854. This then is added to the unique identifier string:
1001:7358:2231:7964:25363122:1223:6854

The colors of the Collections Modalities may be the exact same as the colors of the Talent Modalities. These colors fill the corners of the fourth cell in the same way the Talent Modalities, Intelligences, and Hero Temperaments fill the corners of their respective cells.

The finished result is a four-celled symbol that represents and displays one's digital identity with the primary hero, primary intelligence, primary talent, and primary collection being displayed in the first, second, third, and fourth cells respectively. The secondary, tertiary, and quaternary choices are all layered beneath these primary choices in each cell. These layered choices can be seen by expanding the identity results.

The Mathematics of Matching

It should be further noted that each section of the assessment carries its own weights and sub-weights, all of which are important elements used for the scoring of a match between two or more users whether as a one-to-one demonstration or within a matrix or results.

The weights are as follows:

Heroes: 35%

| Heroes Icons: 17.5% | Hero Temperaments: 17.5% |
|---|---|
| 1. 50% of 17.5% = 8.75% | 1. 50% of 17.5% = 8.75% |
| 2. 30% of 17.5% = 5.25% | 2. 30% of 17.5% = 5.25% |
| 3. 12.5% of 17.5% = 2.1875% | 3. 12.5% of 17.5% = 2.1875% |
| 4. 7.5% of 17.5% = 1.3125% | 4. 7.5% of 17.5% = 1.3125% |

Intelligences: 30%
1. 50% of 30%: 15%
2. 30% of 30%: 9%
3. 12% of 30%: 3.75%
4. 7.5% of 30%: 2.25%

Talents: 25%

| Talents: 12.5% | Talent Modalities: 12.5% |
|---|---|
| 1. 50% of 12.5% = 6.25% | 1. 50% of 12.5% = 6.25% |
| 2. 30% of 12.5% = 3.75% | 2. 30% of 12.5% = 3.75% |
| 3. 12.5% of 12.5% = 1.5625% | 3. 12.5% of 12.5% = 1.5625% |
| 4. 7.5% of 12.5% = 0.9375% | 4. 7.5% of 12.5% = 0.9375% |

Collections: 10%

| Collections: 5% | Collection Modalities: 5% |
|---|---|
| 1. 50% of 5% = 2.50% | 1. 50% of 5% = 2.50% |
| 2. 30% of 5% = 1.50% | 2. 30% of 5% = 1.50% |
| 3. 12.5% of 5% = 0.625% | 3. 12.5% of 5% = 0.625% |
| 4. 7.5% of 5% = 0.375% | 4. 7.5% of 5% = 0.375% |

35% + 30% + 25% + 10% = 100%

As our system and software evolve, please note that the weights may change as well, as may the computational mathematics used for matching.

When comparing one user's unique identification string to another's, these weights are applied to each selection except for the USER ID; the USER ID is strictly there to identify the user, but the ID itself is not used in the mathematical computations applied to matching.

The process for yielding a match score is carried out in the backend database. There are two methods of calculation being used:
1. The Polar Method
2. The Cardinal Method

Consider two different users and compare them.
John: 25:2518:2222:9684:34303115:2324:1874:2133
Mindy: 26:2517:1232:7642:26221307:1324:9186:2133

Comparing User ID #s
John: 25: 2518: 2222: 9684:34303115: 2324: 1874: 2133
Mindy: 26: 2517: 1232: 7642:26221307: 1324: 9186: 2133

We do not compare USER ID's. They hold no relationship significance other than that they act as identifiers for the USER himself/herself.

Comparing the HERO ID's
1. Understand that the full Hero Cell consists of Hero Icons and Hero Temperaments, and is therefore worth 35%.
2. Understand that the Hero Icons are worth 17.5% and the Hero Baskets are worth 17.5%.

Looking at the Hero Icons (Hero ID's), the resulting IDs would be.
John: 25:2518:2222:9684:34303115:2324:1874:2133
Mindy: 26:2517:1232:7642:26221307:1324:9186:2133

Part 1: The Polar Method

The Polar Method is used when comparing two users where neither user is allowed to repeat the same icon in the rest of his or her cells (example: Hero Icons).

Comparing Heroes:
John: 1234
Mindy: 4132

| | | | | |
|---|---|---|---|---|
| John | 1 | 2 | 3 | 4 |
| Mindy | 4 | 1 | 3 | 2 |

Hero Weight Max: 17.5

The first hero choice is always worth 8.75, the second is always worth 5.25, the third is always 2.1875, and the fourth is always 1.3125.

| | | | | |
|---|---|---|---|---|
| John's | 8.75 | 5.25 | 2.1875 | 1.3125 |
| Weights | Hero 1 | Hero 2 | Hero 3 | Hero 4 |
| Mindy's | 8.75 | 5.25 | 2.1875 | 1.3125 |
| Weights | Hero 4 | Hero 1 | Hero3 | Hero 2 |

Next, compare ALL of John's Heroes with Mindy's FIRST Hero. Comparing all of John's heroes to Mindy's 1 st hero, Mindy's 1 st Hero for now is the REFERENCE CELL.

REFERENCE CELL: If there is a match, the system adds John's weight to Mindy's Reference weight, divide by 2, then divide that answer by the reference weight. If the reference weight is smaller than the average, then divide the average by the reference weight. The key is to obtain a percentage.

| | John's Hero | John's Hero | John's Hero | John's Hero |
|---|---|---|---|---|
| | 1, 8.75 | 2, 5.25 | 3, 2.1875 | 4, 1.3125 |
| Mindy's Hero | NO MATCH | NO MATCH | NO MATCH | (8.75 + 1.3125)/ |
| 4, 8.75 | | | | 2 = 5.03125 |
| REFERENCE | | | | Divided by REFERENCE |
| CELL | | | | WEIGHT of 8.75 = |
| | | | | .575 |

Now, do the same with John's heroes compared to Mindy's 2nd, which is now the new reference weight.

| | John's Hero | John's Hero | John's Hero | John's Hero |
|---|---|---|---|---|
| | 1, 8.75 | 2, 5.25 | 3, 2.1875 | 4, 1.3125 |
| Mindy's Hero | NO MATCH | NO MATCH | NO MATCH | (8.75 + 1.3125)/ |
| 4, 8.75 | | | | 2 = 5.03125 |
| REFERENCE | | | | Divided by |
| CELL | | | | REFERENCE |
| | | | | WEIGHT of |
| | | | | 8.75 = 0.575 |
| Mindy's Hero | (8.75 + 5.25)/2 = 7 | NO MATCH | NO MATCH | NO MATCH |
| 1, 5.25 | 7 is bigger than | | | |
| REFERENCE | REFERENCE weight, so | | | |
| CELL | now divide REFERENCE | | | |
| | weight by 7. | | | |
| | 5.25/7 = 0.75 | | | |

Now, compare all of John's to Mindy's 3rd REFERENCE CELL.

| | John's Hero | John's Hero | John's Hero | John's Hero |
|---|---|---|---|---|
| | 1, 8.75 | 2, 5.25 | 3, 2.1875 | 4, 1.3125 |
| Mindy's Hero | NO MATCH | NO MATCH | NO MATCH | (8.75 + 1.3125)/ |
| 4, 8.75 | | | | 2 = 5.03125 |
| REFERENCE | | | | Divided by |
| CELL | | | | REFERENCE |
| | | | | WEIGHT of |
| | | | | 8.75 = 0.575 |
| Mindy's Hero | (8.75 + 5.25)/2 = 7 | NO MATCH | NO MATCH | NO MATCH |
| 1, 5.25 | 7 is bigger than | | | |
| REFERENCE | REFERENCE | | | |
| CELL | weight, so now | | | |
| | divide | | | |
| | REFERENCE | | | |
| | weight by 7. | | | |
| | 5.25/7 = 0.75 | | | |
| Mindy's Hero | NO MATCH | NO MATCH | (2.1875 + 2.1875)/ | No match. |
| 3, 2.1875 | | | 2 = 2.1875 | |
| REFERENCE | | | Divide by | |
| CELL | | | Reference of 2.1875 | |
| | | | 2.1875/2.1875 = 1. | |
| | | | Means 100% | |
| | | | Match here | |

Now, compare all of John's to Mindy's 4th reference cell.

| | John's Hero | John's Hero | John's Hero | John's Hero |
|---|---|---|---|---|
| | 1, 8.75 | 2, 5.25 | 3, 2.1875 | 4, 1.3125 |
| Mindy's Hero | NO MATCH | NO MATCH | NO MATCH | (8.75 + 1.3125)/ |
| 4, 8.75 | | | | 2 = 5.03125 |
| REFERENCE | | | | Divided by |
| CELL | | | | REFERENCE |
| | | | | WEIGHT of |
| | | | | 8.75 = 0.575 |
| Mindy's Hero | (8.75 + 5.25)/ | NO MATCH | NO MATCH | NO MATCH |
| 1, 5.25 | 2 = 7 | | | |
| REFERENCE | 7 is bigger than | | | |
| CELL | REFERENCE | | | |
| | weight, so now | | | |
| | divide | | | |
| | REFERENCE | | | |
| | weight by 7. | | | |
| | 5.25/7 = 0.75 | | | |
| Mindy's Hero | NO MATCH | NO MATCH | (2.1875 + 2.1875)/ | No match. |
| 3, 2.1875 | | | 2 = 2.1875 | |
| REFERENCE | | | Divide by | |
| CELL | | | Reference of 2.1875 | |
| | | | 2.1875/2.1875 = 1. | |
| | | | Means 100% | |
| | | | Match here | |
| Mindy's Hero | NO MATCH | (5.25 + 1.3125)/ | NO MATCH | NO MATCH |
| 2, 1.3125 | | 2 = 3.28125 | | |
| REFERENCE | | Compare to | | |
| CELL | | reference weight | | |
| | | 1.3125/3.28125 = | | |
| | | 0.40 | | |

Now comes the easy part. Look at each row. Wherever there is a match, multiply that match by the hero weight of the row it's in.

| REFERENCE WEIGHTS | JOHN's matches to her |
|---|---|
| 8.75 | .575 |
| 5.25 | .75 |
| 2.1875 | 1.0 |
| 1.3125 | .40 |

8.75(.575) + 5.25(.75) + 2.1875(1.0) + 1.3125(.40) = 11.68125
11.68125 divided by 17.5 = 66.75%

Now, the system compares all of Mindy's to John's reference weights.

| | Mindy's Hero | Mindy's Hero | Mindy's Hero | Mindy's Hero |
|---|---|---|---|---|
| | 4, 8.75 | 1, 5.25 | 3, 2.1875 | 2, 1.3125 |
| John's Hero | NO MATCH | (5.25 + 8.75)/ | NO MATCH | NO MATCH |
| 1, 8.75 | | 2 = 7 | | |
| REFERENCE | | Compare 7 to | | |
| WEIGHT | | Reference | | |
| | | Weight 7/ | | |
| | | 8.75 = 0.80 | | |
| John's Hero | NO MATCH | NO MATCH | NO MATCH | (1.3125 + 5.25)/ |
| 2, 5.25 | | | | 2 = 3.28125 |
| REFERENCE | | | | Compare |
| CELL | | | | 3.28125 to |
| | | | | reference |
| | | | | weight |
| | | | | 3.28125/ |
| | | | | 5.25 = 0.625 |
| John's Hero | NO MATCH | NO MATCH | (2.1875 + 2.1875)/ | No match. |
| 3, 2.1875 | | | 2 = 2.1875 | |
| REFERENCE | | | Divide by Reference | |
| CELL | | | of 2.1875 | |
| | | | 2.1875/2.1875 = 1. | |
| | | | Means 100% | |
| | | | Match here | |
| John's Hero | (8.75 + 1.3125)/ | NO MATCH | NO MATCH | NO MATCH |
| 4, 1.3125 | 2 = 5.03125 | | | |
| REFERENCE | Compare 5.03125 | | | |
| CELL | to reference weight | | | |
| | of 1.3125 | | | |
| | 1.3125/5.03125 = | | | |
| | .2608695652 | | | |
| | Compare to | | | |
| | reference weight | | | |

| REFERENCE WEIGHTS | Mindy's Matches to john |
|---|---|
| 8.75 | .80 |
| 5.25 | .625 |
| 2.1875 | 1.0 |
| 1.3125 | .2608695652 |

8.75(.80) + 5.25(.625) + 2.1875(1) + 1.3125(.2608695652) = 12.811141304
12.8111413043 divided by 17.5 = 73.20652174%

Now, the system averages out both percentages:
(66.75%+73.20652174%)/2=69.978%

Next, is disclosed the Cardinal Method.

The Cardinal Method

The system can use the Cardinal Method for comparing two users in instances when both users are allowed to have repeated icons for all their choices (example: Hero Temperaments).

For the following example, consider if John and Mindy chose the following:
John: King, King, Magician, Magician
Mindy; King, King, Magician, Magician

The database will recognize these as:
John: 1133
Mindy: 1133

| | | | | |
|---|---|---|---|---|
| John | 1 | 1 | 3 | 3 |
| Mindy | 1 | 1 | 3 | 3 |

This is a 100% match—to show it mathematically:
HERO Temperament WEIGHT MAX: 17.5

| | | | | |
|---|---|---|---|---|
| John's | 8.75 | 5.25 | 2.1875 | 1.3125 |
| Weights | Temp 1 | Temp 1 | Temp 3 | Temp 3 |
| Mindy's | 8.75 | 5.25 | 2.1875 | 1.3125 |
| Weights | Temp 1 | Temp 1 | Temp 3 | Temp 3 |

Now, compare John's to Mindy's, with Mindy's weights being the Reference Weights.

| | John's Temp | John's Temp | John's Temp | John's Temp |
|---|---|---|---|---|
| | 1, 8.75 | 1, 5.25 | 3, 2.1875 | 3, 1.3125 |
| Mindy's Temp | MATCH! | MATCH! | NO MATCH | NO MATCH |
| 1, 8.75 | (8.75 + 8.75)/ | (5.25 + 8.75)/ | | |
| REFERENCE | 2 = 8.75 | 2 = 7 | | |
| CELL | Compare 8.75 to | Compare 7 to | | |
| | Reference | reference | | |
| | Weight | weight. | | |
| | 8.75/8.75 = 1 | 7/8.75 = .80 | | |
| | 100% Match | 80% Match | | |
| Mindy's Temp | (5.25 + 8.75)/ | (5.25 + 5.25)/ | NO MATCH | NO MATCH |
| 1, 5.25 | 2 = 7 | 2 = 5.25 | | |
| REFERENCE | Compare 7 to | Compare 5.25 to | | |
| CELL | Reference | Reference | | |
| | Weight. | Weight. | | |
| | 5.25/7 = | 5.25/5.25 = | | |
| | 0.75 = 75% | 1.0 = 100% | | |
| | Match | Match | | |
| Mindy's Temp | NO MATCH | NO MATCH | (2.1875 + 2.1875)/ | (2.1875 + 1.3125)/ |
| 3, 2.1875 | | | 2 = 2.1875 | 2 = 3.5 |
| REFERENCE | | | Compare 2.1875 to | Compare 3.5 to |
| CELL | | | Reference Weight. | Reference Weight. |
| | | | 2.1875/2.1875 = | 2.1875/3.5 = |
| | | | 1.0 = 100% Match. | .625 = 62.5% Match |
| Mindy's Temp | NO MATCH | NO MATCH | (1.3125 + 2.1875)/ | (1.3125 + 1.3125)/ |
| 3, 1.3125 | | | 2 = 1.75 | 2 = 1.3125 |
| REFERENCE | | | Compare 1.75 to | Compare 1.3125 to |
| CELL | | | Reference Weight. | Reference Weight. |
| | | | 1.3125/1.75 = | 1.3125/1.3125 = |
| | | | .75 = 75% Match. | 1.0 = 100% Match |

Here the matches are lined up with reference cells and added together, just like before, but there is a difference. Not all the matched weights are incorporated per reference weight. Instead, the calculation only includes the highest weight. For example, for Mindy's reference weight of 8.75, John matched 20%, 30%, 29%, and 100% for that row. The system only multiplies 8.75 by 100%. The reason for this is that the system only uses the highest matches. All lower matches are discarded.

Taking the highest matches:

8.75(100%)+5.25(100%)+2.1875(100%)+1.3125(100%)=17.5→17.5/17.5=100%

Match

To bring all this together, the system needs a final score for the Heroes section alone, which would be the average of the percent match between the Hero ID+the Hero Temperament ID between both users. If John and Mindy's Heroes are a 69.978% Match, and their Hero Temperaments are a 66.175% match, the average of the two to receive a Hero Section Match Score of 68.0765%.

This completes the Heroes section. In total, there are seven types of ID's that need to be compared between two users in order to show a match score:
1. Hero Icons, using the Polar Method
2. Hero Temperaments, using the Cardinal Method
3. Intelligences, using the Polar Method
4. Talents, using the Polar Method
5. Talent Modalities, using the Cardinal Method
6. Collections, using the Polar Method
7. Collection Modalities, using the Cardinal Method

All seven of these scores are averaged out to yield an overall match score. This match score can be shown on-screen when users decide to match with each other. The match score itself can also catalogued in the database and recorded; furthermore, a major match matrix can also be run between all users on the platform using an advanced version of this computational analysis consisting of matrices.

The disclosure next turns to the specific examples provided in the figures.

### REFERENCE NUMERALS IN THE FIGURES

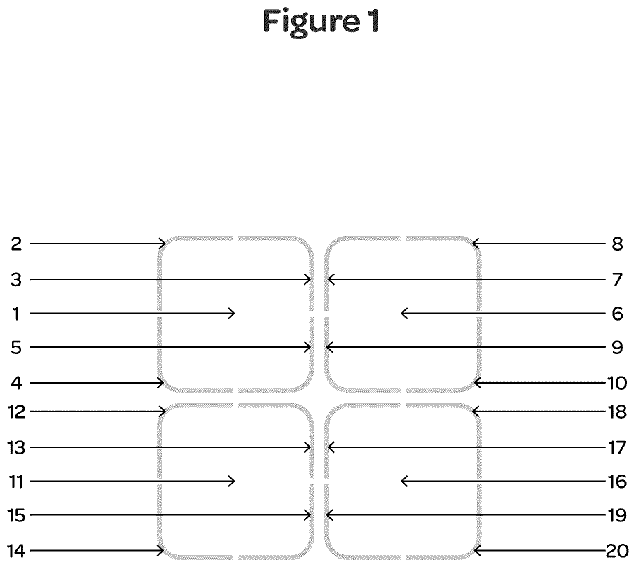

FIG. 1: IdentityTest Structure

```
  1. Heroes cell
  2. Heroes Corner 1
  3. Heroes Corner 2
  4. Heroes Corner 3
  5. Heroes Corner 4
  6. Intelligence cell
  7. Intelligence Corner 1
  8. Intelligence Corner 2
  9. Intelligence Corner 3
10. Intelligence Corner 4
11. Talents cell
12. Talents Corner 1
13. Talents Corner 2
14. Talents Corner 3
15. Talents Corner 4
16. Collection cell
17. 17. Collections Corner 1
18. Collections Corner 2
19. Collections Corner 3
20. Collections Corner 4
```

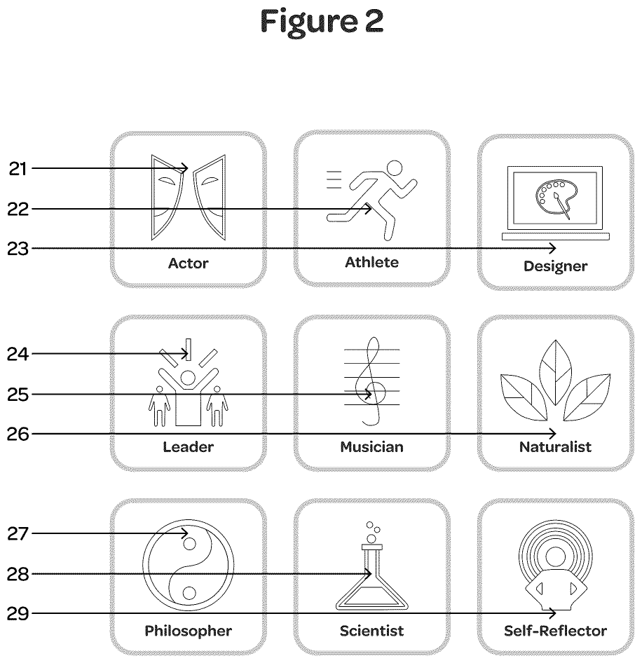

FIG. 2: Heroes

21. Actor
22. Athlete
23. Designer
24. Leader
25. Musician
26. Naturalist
27. Philosopher
28. Scientist
29. Self-Reflector

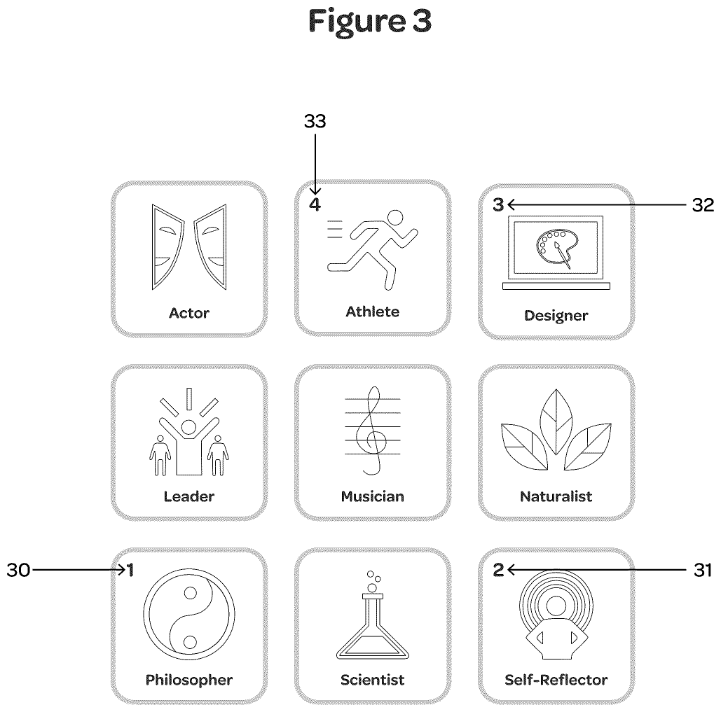

FIG. 3: Hero Ranking

30. Hero Choice #1
31. Hero Choice #2
32. Hero Choice #3
33. Hero Choice #4

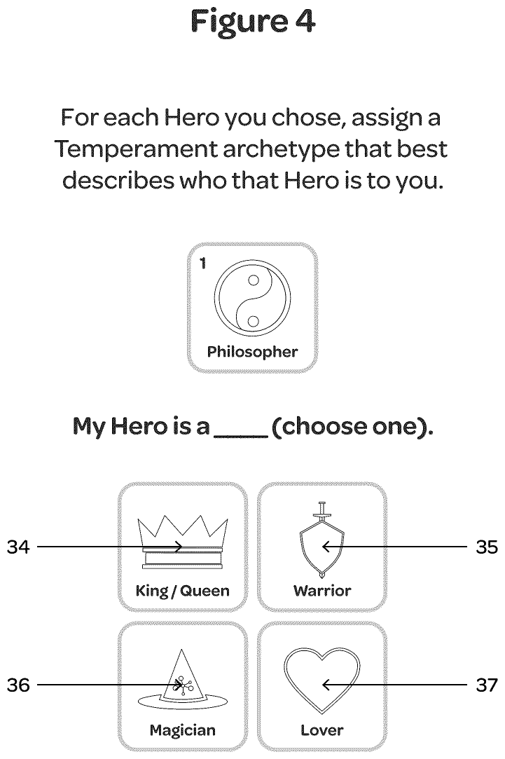

FIG. 4: KWML Assignment

34. King/Queen Temperament
35. Warrior Temperament
36. Magician Temperament
37. Lover Temperament

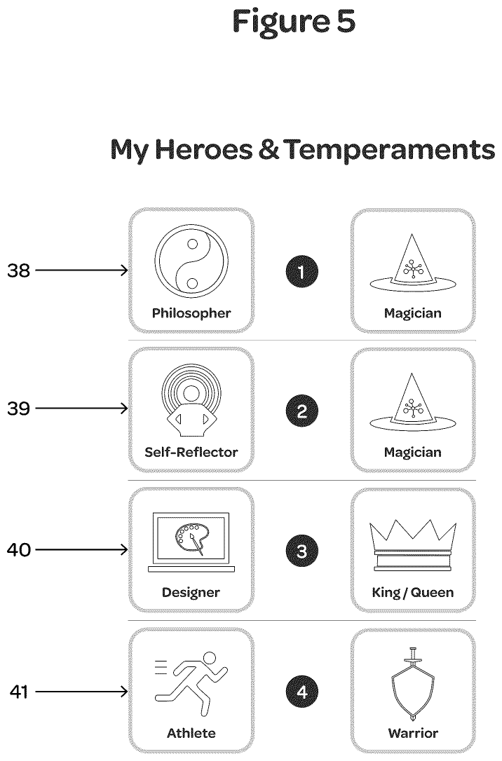

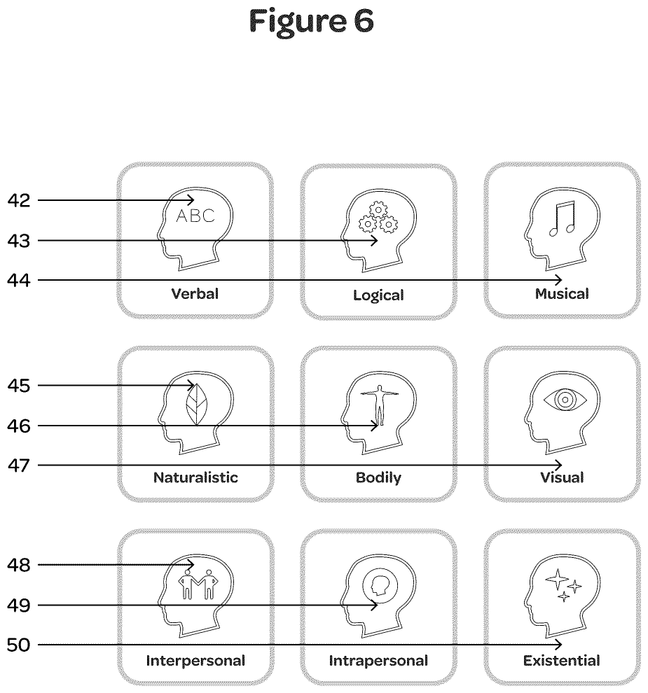

FIG. 5: Heroes Results
38. Hero #1+Temperament #1
39. Hero #2+Temperament #2
40. Hero #3+Temperament #3
41. Hero #4+Temperament #4
FIG. 6: Intelligences

42. Verbal-Linguistic Intelligence
43. Logical-Mathematical Intelligence
44. Musical Intelligence
45. Naturalistic Intelligence
46. Bodily-Kinesthetic Intelligence
47. Visual-Spatial Intelligence
48. Interpersonal Intelligence
49. Intrapersonal Intelligence
50. Existential Intelligence

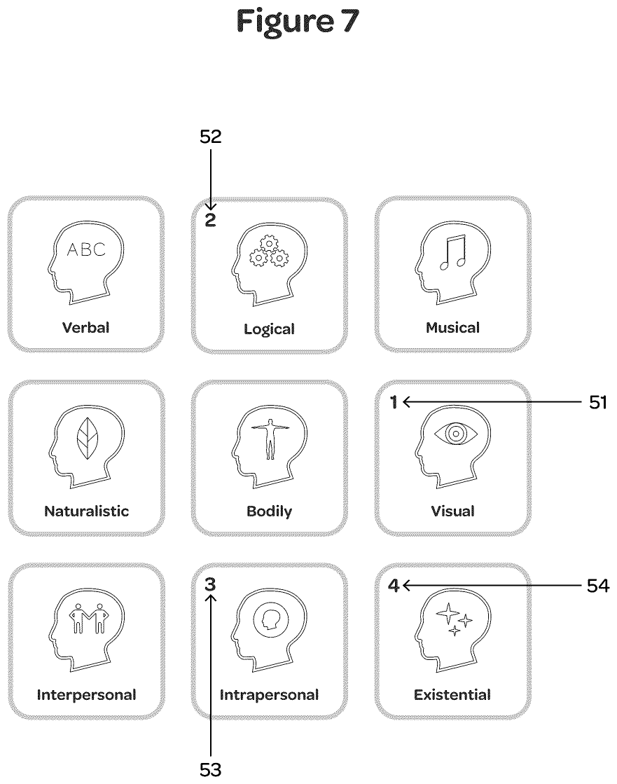

FIG. 7: Intelligence Ranking

51. First Intelligence Choice
52. Second Intelligence Choice
53. Third Intelligence Choice
54. Fourth Intelligence Choice

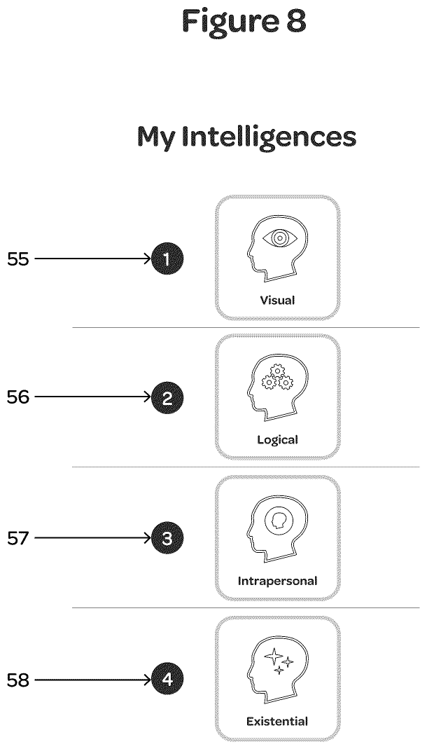

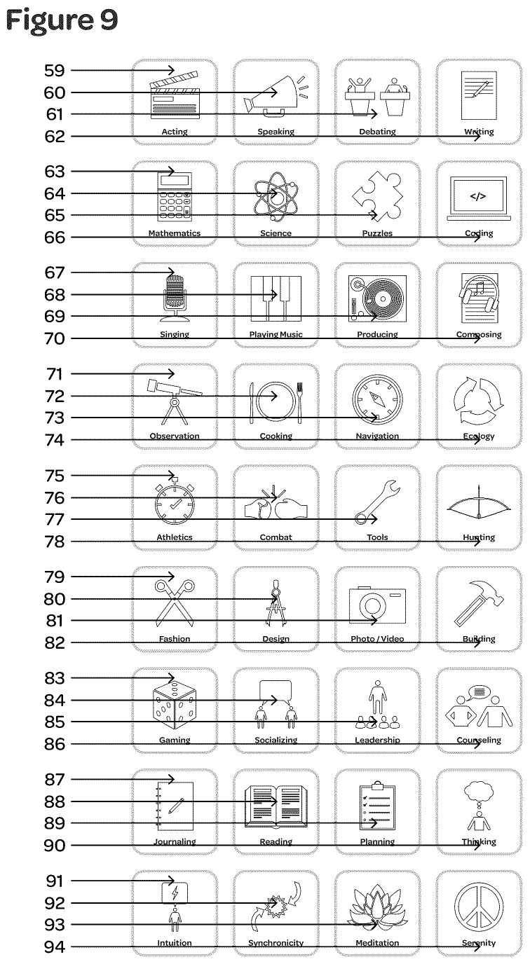

FIG. 8: Intelligences Rank Screen
55. First intelligence Ranked
56. Second Intelligence Ranked
57. Third Intelligence Ranked
58. Fourth Intelligence Ranked
FIG. 9: Talent Choices

59. Acting
60. Speaking
61. Debating
62. Writing
63. Mathematics
64. Science
65. Puzzles
66. Coding
67. Singing
68. Playing Music
69. Producing
70. Composing
71. Observing
72. Cooking
73. Navigation
74. Ecology
75. Athletics
76. Combat
77. Tools
78. Hunting
79. Fashion/Style
80. Design
81. Photo/Video
82. Building
83. Gaming
84. Socializing
85. Leadership
86. Counseling
87. Journaling
88. Reading
89. Planning
90. Thinking
91. Intuition
92. Synchronicity
93. Meditation
94. Serenity

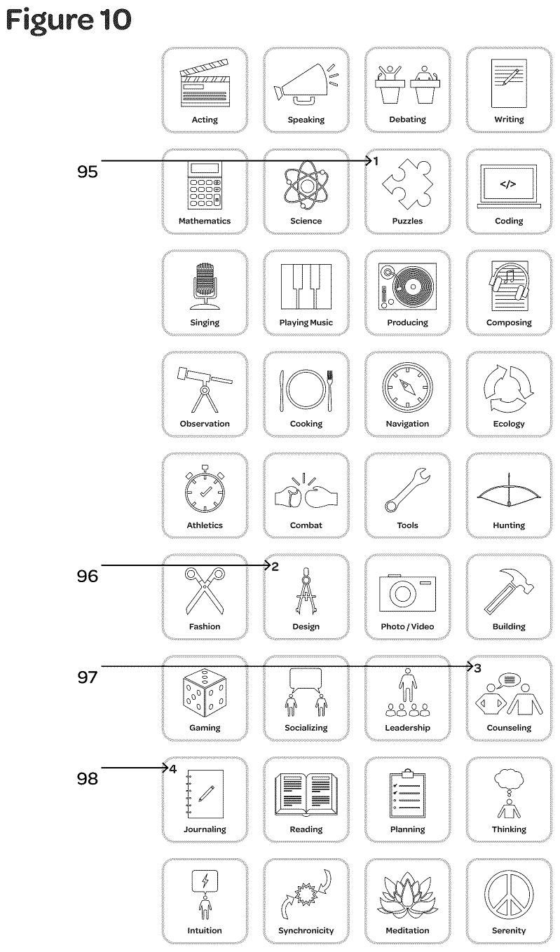

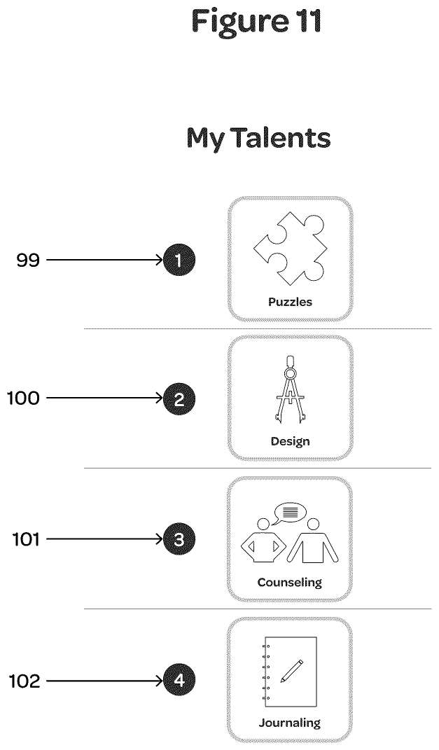

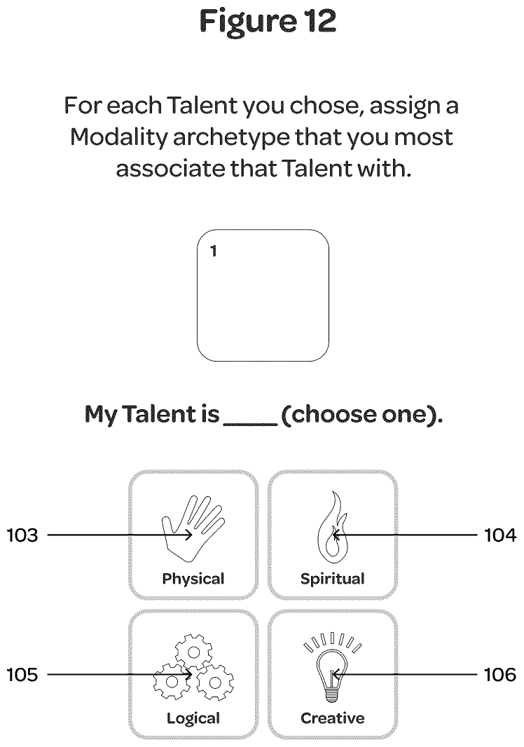

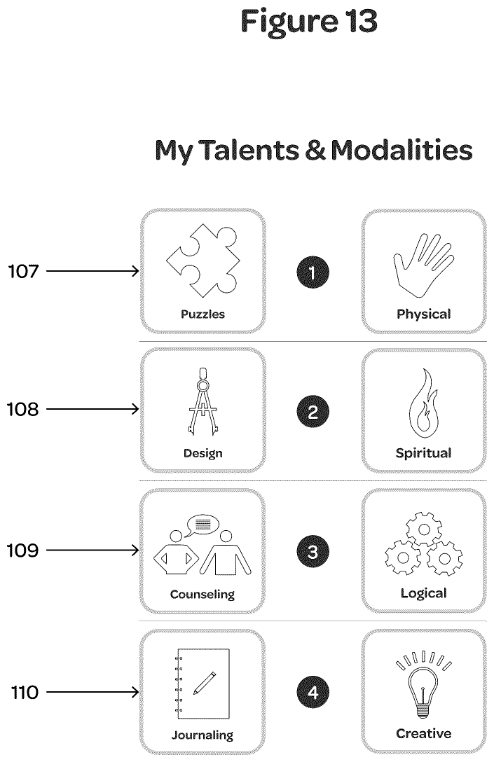

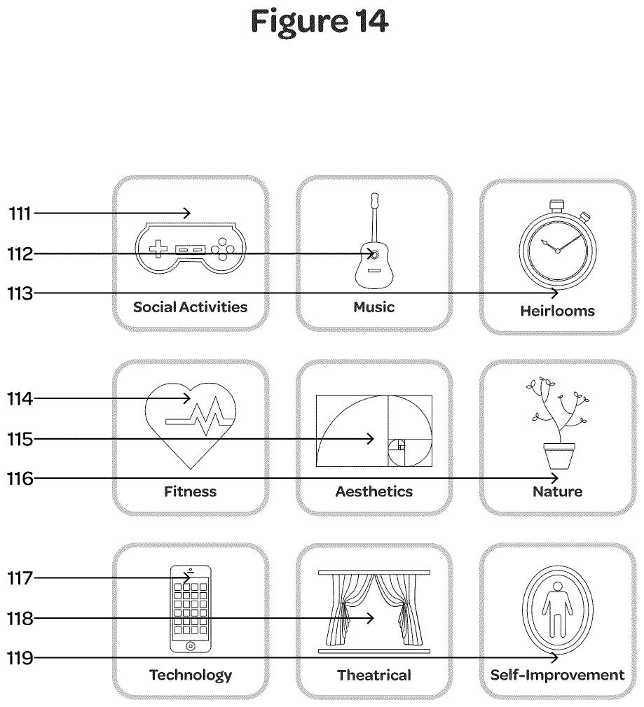

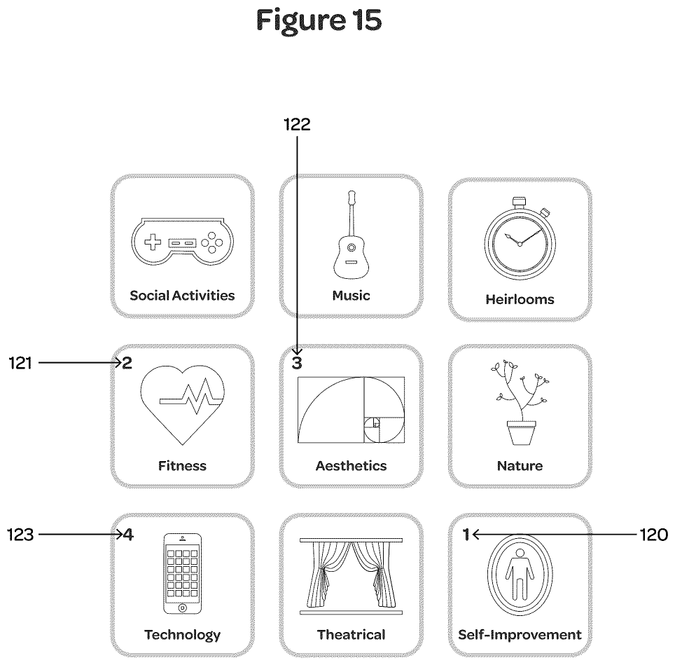

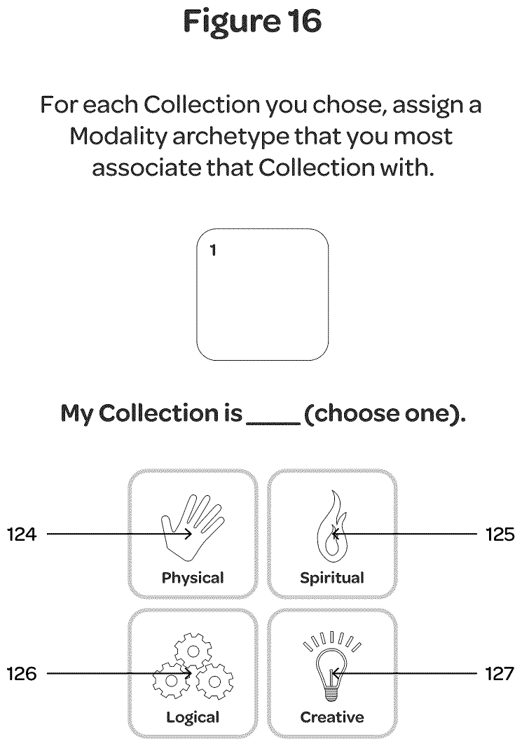

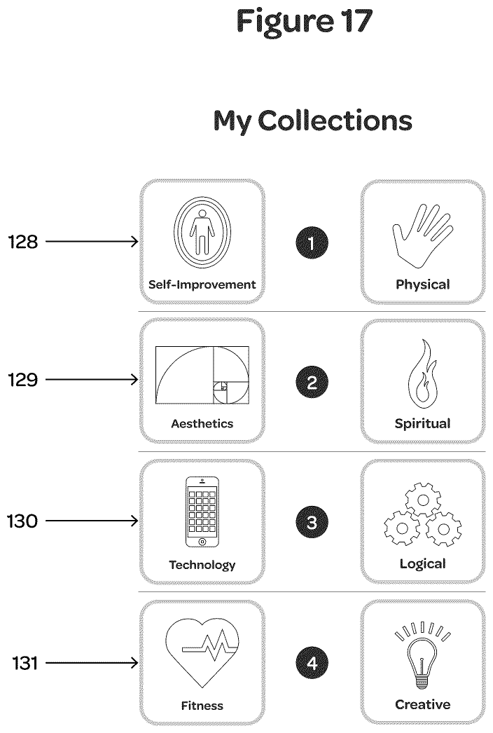

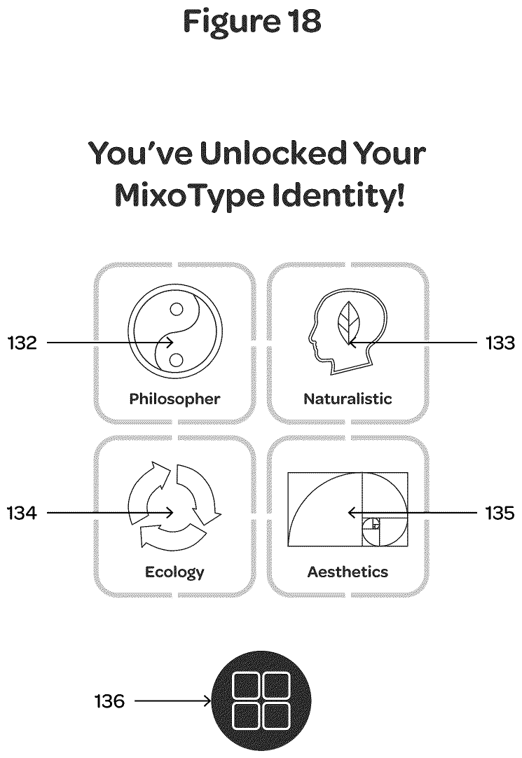

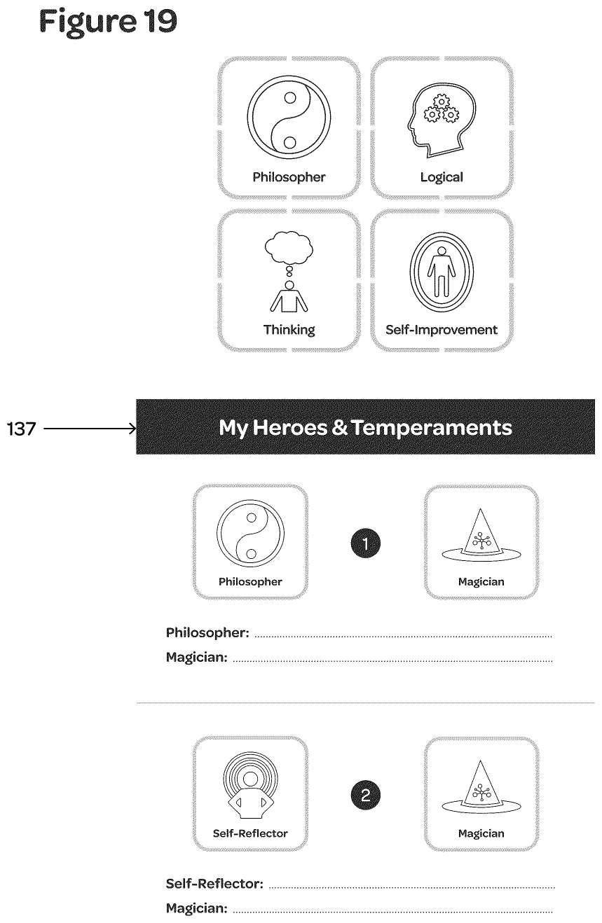

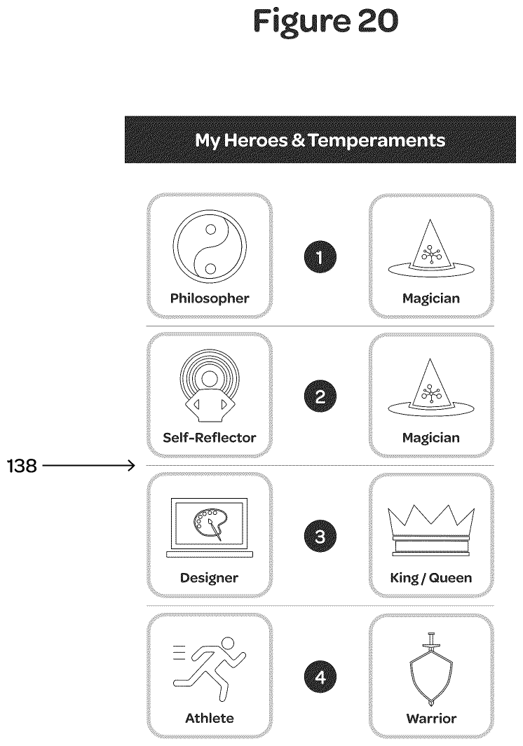

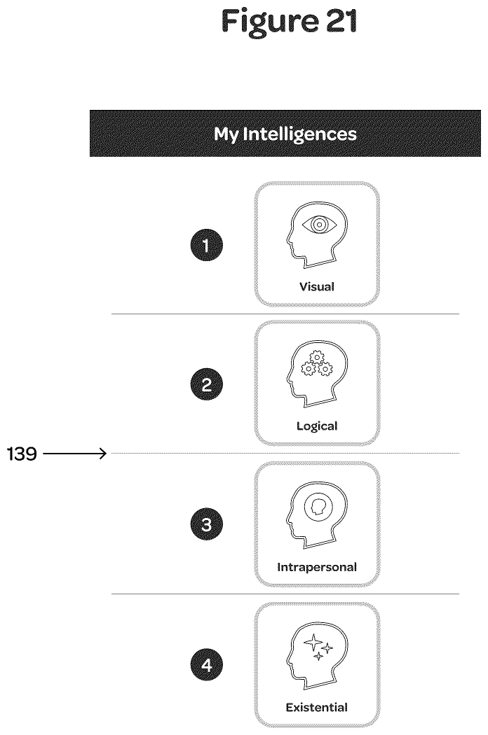

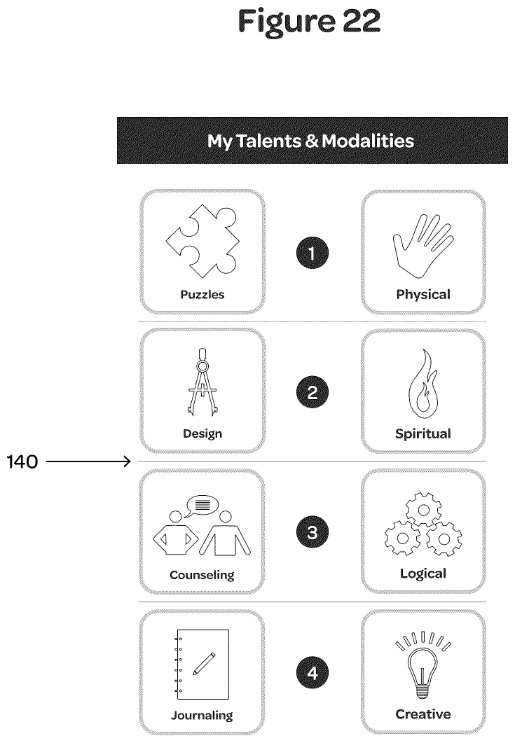

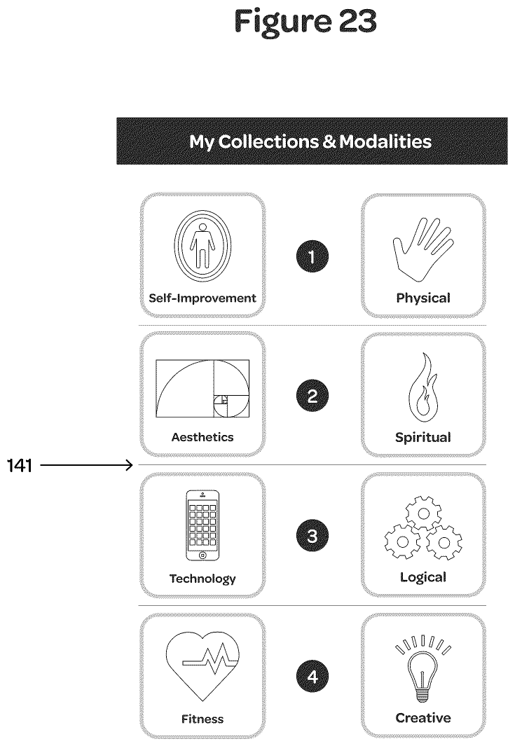

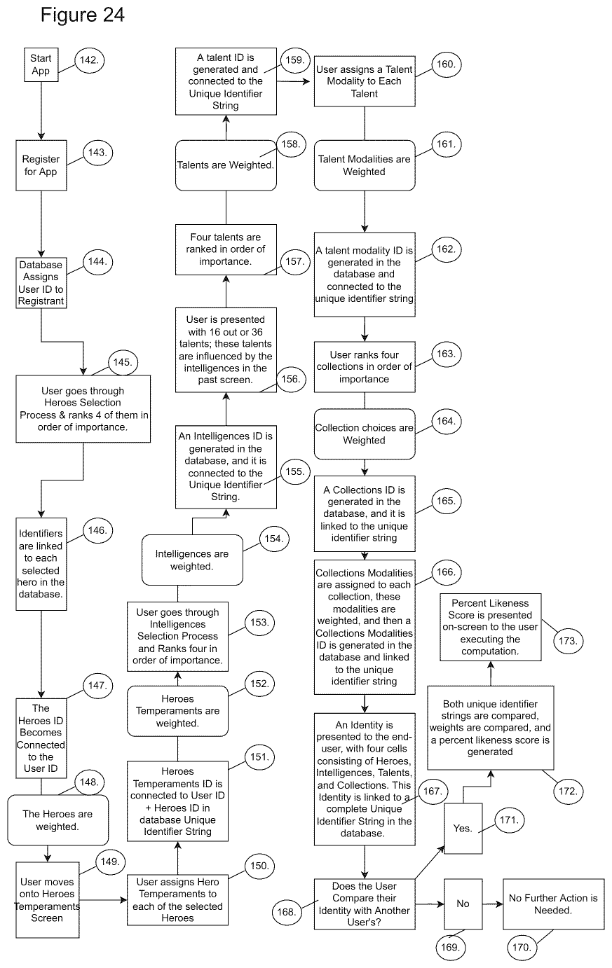

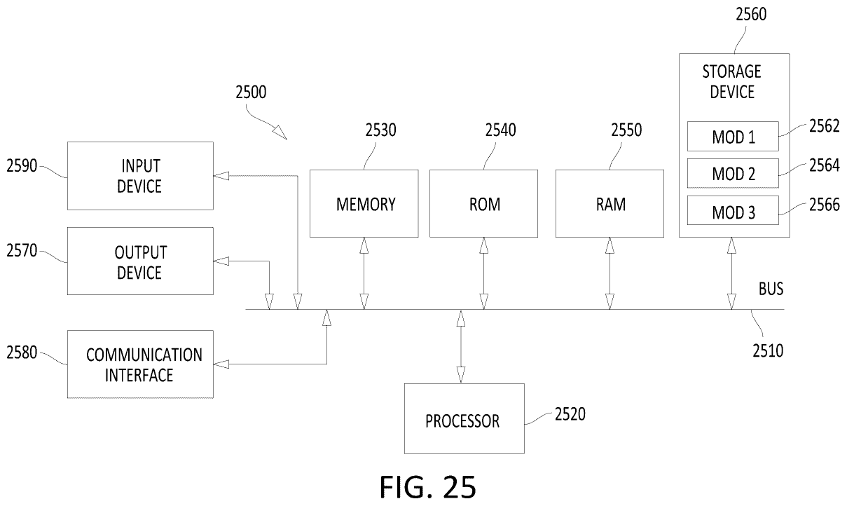

FIG. 10: Talent Selection
95. Talent Selection 1
96. Talent Selection 2
97. Talent Selection 3
98. Talent Selection 4
FIG. 11: Talent Rank
99. Talent Rank 1
100. Talent Rank 2
101. Talent Rank 3
102. Talent Rank 4
FIG. 12: PSLC Assignment
103. Physical
104. Spiritual
105. Logical
106. Creative
FIG. 13: Talents+PSLC Summary
107. Talent 1+PSLC Assignment 1
108. Talent 2+PSLC Assignment 2
109. Talent 3+PSLC Assignment 3
110. Talent 4+PSLC Assignment 4
FIG. 14: Collections
111. Social Activities
112. Fitness
113. Technology
114. Music
115. Heirlooms
116. Aesthetics
117. Nature
118. Theatrical
119. Self-Improvement
FIG. 15: Collections Ranking
120. Collection Choice #1
121. Collection Choice #2
122. Collection Choice #3
123. Collection Choice #4
FIG. 16. PSLC Assignment
124. Physical
125. Spiritual
126. Logical
127. Creative
FIG. 17: Collections+Collection Modalities
128. Collection Choice #1+PSLC Assignment 1
129. Collection Choice #2+PSLC Assignment 2
130. Collection Choice #3+PSLC Assignment 3
131. Collection Choice #4+PSLC Assignment 4
FIG. 18: Finished Identity Structure
132. Identity Cell #1
133. Identity Cell #2
134. Identity Cell #3
135. Identity Cell #4
136. Expanded Identity Results Button
FIG. 19: Pop-up Results Screen
137. Pop-Up Results Screen
FIG. 20: Heroes & Temperaments Expanded Results
138. Heroes & Temperaments Expanded Results
FIG. 21: Talents and Modalities Expanded Results
139. Intelligences Expanded Results
FIG. 22: My Talents & Modalities Expanded Results
140. My Talents & Modalities Expanded Results
FIG. 23: My Collections & Modalities Expanded Results
141. My Collections and Modalities Expanded Results
FIG. 24: Master Flowchart
FIG. 25: General Purpose Computing Device 2500

The drawings and specific descriptions of the figures, as well as any specific or alternative embodiments discussed, are intended to be read in conjunction with the entirety of this disclosure. The systems for and methods of generating and digitizing an identity may, however, be embodied in many different forms and should not be construed as being limited to the embodiments set forth herein. Rather, these embodiments are provided by way of illustration only, and so that this disclosure will be thorough, complete, and fully convey understanding to those skilled in the art.

FIG. 1 illustrates an example of an unlabeled four-celled identity diagram. When users see others' identity results, they can interpret what that user's Identity is according to the layout of this diagram. Subsequent figures explain this figure in greater detail. Heroes Cell (1) contains the information for all the Hero choices, but it only shows the primary Hero. The secondary, tertiary, and quaternary Heroes can be seen in an expanded view (see FIG. 20 for an expanded view). However, users can see the King/Queen, Warrior, Magician, and Lover assignments for each Hero. The King/Queen, Warrior, Magician, and Lover assignments shall also be referred to as “KWML” interchangeably throughout this document, and they show up as the colored corners of the Heroes Cell. Heroes Corner #1 (2) contains the KWML assignment for the primary Hero. Heroes Corner #2 (3) contains the KWML assignment for the secondary Hero. Heroes Corner #3 (4) contains the KWML assignment for the tertiary Hero, and Heroes Corner #4 (5) contains the KWML assignment for the quaternary Hero.

Intelligence cell (6) contains the information for all the Intelligence choices; but it only shows the primary Intelligence. The secondary, tertiary, and quaternary Intelligences can be seen in an expanded view (see FIG. 21 for the expanded view). The Intelligence colors, however, appear in each of the corners of the Intelligence Cell (6). There is no further assignment for the Intelligences, so each Intelligence itself has a color that corresponds to its respective corner. Intelligence Corner #1 (7) is the first Intelligence choice and its corresponding color. Intelligence Corner #2 (8) is the second Intelligence choice and its corresponding color. Intelligence Corner #3 (9) is the third Intelligence choice and its corresponding color. Intelligence Corner #4 (10) is the fourth Intelligence choice and its corresponding color.

The Talents Cell (11) contains the information for all the Talent choices, but it only shows the primary Talent. The secondary, tertiary, and quaternary Talents can be seen in expanded view (see FIG. 22). However, users can see the Physical, Spiritual, Logical, and Creative assignments for each Talent. The Physical, Spiritual, Logical, and Creative assignments shall also be referred to as PSLC interchangeably throughout this document. Talents Corner #1 (12) contains the KWML assignment for the primary Talent. Talents Corner #2 (13) contains the PSLC assignment for the secondary Talent. Talents Corner #3 (14) contains the PSLC assignment for the tertiary Talent, and Talents Corner #4 (15) contains the PSLC assignment for the quaternary Talent. Each PSLC archetype has its own color, and this color fills in the respective corner for the Talents Cell (11).

The Collections Cell (16) contains the information for all the Collection choices, but it only shows the primary Collection. The secondary, tertiary, and quaternary Intelligences can be seen in an expanded view (see FIG. 23). However, users can see the PSLC collection. Collections Corner #1 (17) contains the PSLC assignment for the primary Collection. Collections Corner #2 (18) contains the PSLC assignment for the secondary Collection. Collections Corner #3 (19) contains the PSLC assignment for the tertiary Collection, and Collection Corner #4 (20) contains the PSLC assignment for the quaternary Hero. Each PSLC archetype has its own color, and this color fills in the respective corner for the Collections Cell (16).

FIG. 2 illustrates an example army of selectable “Heroes” users can select from. The first section of the identity assessment, and it is in this section that the nine types of selectable Heroes can be presented to the user. The user picks the four that are most important and/or relevant to them. The definitions for these roles were described above. As illustrated, Actor (21) is the first available choice; Athlete (22) is the second available choice; Designer (23) is the third available choice; Leader (24) is the fourth available choice: Musician (25) is the fifth available choice; Naturalist (26) is the sixth available choice; Philosopher (27) is the seventh available choice; Scientist (28) is the eight available choice; and Self-Reflector (29) is the ninth available choice.

FIG. 3 illustrates an example of four Heroes being selected and ranked in order of importance. In this case, those Heroes are Philosopher (30), Self-Reflector (31), Designer (32), and Athlete (33).

FIG. 4 illustrates an example of four Temperament archetypes that can be assigned to each Hero. In this case, the user has the possibility of assigning either King/Queen (34), Warrior (35), Magician (36), Lover (37) to their hero selections.

FIG. 5 illustrates an example of a user's selected Heroes shown next to their assigned Temperaments (Philosopher (38), Self-reflector (39), Designer (40), and Athlete (41) linked to the Hero Temperaments they assigned to them. The Hero Temperaments show up as colors in the finished Hero Cell (see FIG. 18).

FIG. 6 illustrates an example array of selectable “Intelligences” users can select from. Here, the user is shown nine different Intelligence options, the definitions of which were provided earlier. Options include: Verbal-Linguistic Intelligence (42), Logical Intelligence (43), Musical Intelligence (44), Naturalistic Intelligence (45), Bodily Intelligence (46), Visual Intelligence (47), Interpersonal Intelligence (48), Intrapersonal Intelligence (49), and Existential Intelligence (50).

FIG. 7 illustrates an example process through which users can assign their selected Intelligences an order of importance. In this example, those Intelligences are Verbal-Linguistic (51), Naturalistic (52), Interpersonal (53), and Logical (54).

FIG. 8 illustrates an example of a user's selected Intelligences in their rank order. As illustrated, the user has selected Visual (55), Logical (56), Intrapersonal (57), and Existential (58).

FIG. 9 illustrates an example array of selectable “Talents” users can select from. Please keep in mind that more talents may be added in the future, and some may be dropped. Furthermore, only sixteen Talents can be seen by any individual since the Intelligences trigger the available Talent selections. For simplicity, all the available Talents are shown. All the Talent selections are clearly labeled from numbers 59 to 94. These are: Acting (59), Speaking (60), Debating (61), Writing (62), Mathematics (63), Science (64), Puzzles (65), Coding (66), Singing (67), Playing Music (68), Producing (69), Composing (70), Observing (71), Cooking (72), Navigation (73), Ecology (74), Athletics (75), Combat (76), Tools (77), Hunting (78), Fashion/Style (79), Design (80), Photo/Video (81), Building (82), Gaming (83), Socializing (84), Leadership (85), Counseling (86), Journaling (87), Reading (88), Planning (89), Thinking (90), Intuition (91), Synchronicity (92), Meditation (93), Serenity (94).

FIG. 10 illustrates an example process through which users can assign their selected Talents an order of importance-Puzzles (95), Design (96), Counseling (97), and Journaling (98).

FIG. 11 illustrates an example of a user's selected Talents in their rank order. In this example, Puzzles (99) is most important, followed by Design (100), Counseling (101), and Journaling (102).

FIG. 12 illustrates an example of four Modality archetypes that can be assigned to each Talent-Physical (103), Spiritual (104), Logical (105), and Creative Talent Modalities (106) for each of the chosen Talents. Users may assign only one Talent Modality to each Talent, but may repeat the Talent Modality on different Talents.

FIG. 13 illustrates an example of a user's selected Talents-Puzzles (107), Design (108), Counseling (109), and Journaling (11)—shown next to their assigned Modalities. Everything is ranked in order of importance.

FIG. 14 illustrates an example array of selectable “Collections” users can select from. Exemplary Collections can include: Social Activities (111), Music (112), Heirlooms (113), Fitness (114), Aesthetics (115), Nature (116), Technology (117), Theatrical (118), and Self-Improvement (119). The definitions were provided earlier.

FIG. 15 illustrates an example process through which users can assign their selected Collections an order of importance. In this example, the user selects Self-Improvement (120) as first, Fitness (121) as second, Aesthetics (122) as third, and Technology (123) as fourth.

FIG. 16 illustrates an example of four Modality archetypes that can be assigned to each Collection. In this example, the Modality archetypes include: Physical (124), Spiritual (125), Logical (126), and Creative (127). Collection Modalities can be assigned to each of the Collections, following a similar fashion to the Hero Temperaments and the Talent Modalities being assigned to their respective Heroes and Talents.

FIG. 17 illustrates an example of a user's selected Collections-Self-Improvement (128), Aesthetics (129), Technology (130), and Fitness (131)—shown next to their assigned Modalities.

FIG. 18 illustrates an example of a user's finished identity structure, which shows all (Hero, Intelligence, Talent, and Collection) aspects, with a button (136) that allows the user to expand the results. The identity structure shows the Primary Hero Cell (132). The corners of the Hero Cell (132) can be colored to represent the selected Temperaments assigned to each of the Heroes in the Hero cell, with the primary Hero in the center of this cell. The identity structure also shows the Primary Intelligences cell (133), with the primary Intelligence in the center of this cell, and the corners can have different colors to represent the various Intelligences chosen. The identity structure shows the Primary Talent cell (134) with different Talent Modalities displayed using colored corners of the Primary Talent cell (134), and with each Modality choices being linked to each of the Talent choices made by the user. Finally, the identity structure can illustrate the primary Collections cell (135). Here, the primary Collection selected can be in the center of the cell (135), with the corners of the Collections cell (135) representing the Collection Modalities assignments to each chosen Collection using colors. Users can click the button (136) to see an expanded results view.

FIG. 19 illustrates an example expansion (137) of a finished identity structure once the expansion button (136) is tapped.

FIG. 20 illustrates an example of a user's selected Heroes (138) with accompanying Temperaments.

FIG. 21 illustrates an example of a user's selected Intelligences (139).

FIG. 22 illustrates an example of a user's selected Talents (140) and accompanying Modalities.

FIG. 23 illustrates an example of a user's selected Collections (141) and accompanying Modalities.

FIG. 24 illustrates an example process for generating an identity structure. This process can, for example, be executed by a computer system running on a server, in the cloud, or on an individual's home computer/mobile device. The Software Application (“App”) (which can be a software program, mobile phone application (“app”), etc.) begins (142), and the user registers the app (143). Data associated with the registration can be captured in a database (such as a cloud-based server or other backend database). The database assigns a user ID (Identification) to the registrant (144). This User ID is unique in that it is a number uniquely assigned to only this user. In some configurations the number assigned is based on the order in which the user signed up numerically in relation to other users who also signed up previously.

The user then begins making selections to generate their Identity profile. First, the user undergoes the Heroes selection process (145). Then the system generates an identifier code (146) for the heroes selected and this code is added to the user ID (147) (with the end goal of generating a unique identifier string). The heroes choices are weighted (148), and the user begins selecting Heroes Temperaments (149). The user assigns a Hero Temperament to each of the selected Heroes (150), with the system generating a Heroes Temperaments ID is generated and connected to the unique identifier string (151) that is being generated along the way. The Hero Temperaments are weighted (152).

The user then begins making selections regarding Intelligence (153) with the user performing an intelligence selection process in which four are ranked in order of importance. The selected intelligences are weighted (154), and the system generates an intelligences ID (155) which is connected to the Unique Identifier String. The user can is then presented with talents from which they can make a selection (156), where the talents presented are influenced by the previously selected intelligences. The user ranks the talents in order of importance (157) and the system weights the talents (158). The system generates a talent ID (159) based on the selected talents and connects the talent ID to the unique identifier string that is being generated along the way. The user then assigns a Talent Modality to each talent (160), and the systems weights those talent modalities (161). A talent modality ID is generated (162) and is connected to the unique identifier string.

The user can then make selections regarding Collections (163). Those selections can be weighted (164), and the system can generate a Collections ID (165), with the Collections ID linked to the unique identifier string that is being generated along the way. Modalities for the selected Collections are selected (166), weighted, and a Collections Modalities ID is generated in and is linked to the unique identifier string.

At this point the user's Identity Structure has been generated, with four cells consisting of Heroes, Intelligences, Talents, and Collections, respectively. If the user wishes to compare their Identity with another user's identity (167), they may do so. If so (171), both the unique string identifier of the user's Identity Structure and the unique string identifier of the other user's Identity Structure are compared, and a percent likeness score can be generated (172). That percent likeness (aka, a similarity score) can then be presented to the user (173). If the user does not wish to compare their identity (169), no further action is needed (170).

FIG. 25 illustrates an exemplary computer system configured to execute the disclosed system, and can include a general-purpose computing device 2500, including a processing unit (CPU or processor) 2520 and a system bus 2510 that couples various system components including the system memory 2530 such as read-only memory (ROM) 2540 and random-access memory (RAM) 2550 to the processor 2520. The system 2500 can include a cache of high-speed memory connected directly with, in close proximity to, or integrated as part of the processor 2520. The system 2500 copies data from the memory 2530 and/or the storage device 2560 to the cache for quick access by the processor 2520. In this way, the cache provides a performance boost that avoids processor 2520 delays while waiting for data. These and other modules can control or be configured to control the processor 2520 to perform various actions. Other system memory 2530 may be available for use as well. The memory 2530 can include multiple different types of memory with different performance characteristics. It can be appreciated that the disclosure may operate on a computing device 2500 with more than one processor 2520 or on a group or cluster of computing devices networked together to provide greater processing capability. The processor 2520 can include any general-purpose processor and a hardware module or software module, such as module 1 2562, module 2 2564, and module 3 2566 stored in storage device 2560, configured to control the processor 2520 as well as a special-purpose processor where software instructions are incorporated into the actual processor design. The processor 2520 may essentially be a completely self-contained computing system, containing multiple cores or processors, a bus, memory controller, cache, etc. A multi-core processor may be symmetric or asymmetric.

The system bus 2510 may be any of several types of bus structures including a memory bus or memory controller, a peripheral bus, and a local bus using any of a variety of bus architectures. A basic input/output (BIOS) stored in ROM 2540 or the like, may provide the basic routine that helps to transfer information between elements within the computing device 2500, such as during start-up. The computing device 2500 further includes storage devices 2560 such as a hard disk drive, a magnetic disk drive, an optical disk drive, tape drive or the like. The storage device 2560 can include software modules 2562, 2564, 2566 for controlling the processor 2520. Other hardware or software modules are contemplated. The storage device 2560 is connected to the system bus 2510 by a drive interface. The drives and the associated computer-readable storage media provide nonvolatile storage of computer-readable instructions, data structures, program modules and other data for the computing device 2500. In one aspect, a hardware module that performs a particular function includes the software component stored in a tangible computer-readable storage medium in connection with the necessary hardware components, such as the processor 2520, bus 2510, display 2570, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 2500 is a small, handheld computing device, a desktop computer, or a computer server.

Although the exemplary embodiment described herein employs the hard disk 2560, other types of computer-readable media which can store data that are accessible by a computer, such as magnetic cassettes, flash memory cards, digital versatile disks, cartridges, random access memories (RAMs) 2550, and read-only memory (ROM) 2540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 2500, an input device 2590 represents any number of input mechanisms, such as a microphone for speech, a touch-sensitive screen for gesture or graphical input, keyboard, mouse, motion input, speech and so forth. An output device 2570 can also be one or more of a number of output mechanisms known to those of skill in the art. In some instances, multimodal systems enable a user to provide multiple types of input to communicate with the computing device 2500. The communications interface 2580 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: assigning to a first user, via at least one processor of a computer system, a user identification (ID); receiving, at the computer system from the first user, at least one user identity selection having a ranked order; generating, via the at least one processor for each personality selection within the at least one user identity selection, and identity ID; combining, via the at least one processor, the user ID and the identity ID to form a user identity of the first user; receiving, at the computer system from the first user, a selection of a second user; comparing, via the at least one processor, the user identity to another identity of the second user, resulting in a comparison; and displaying, via a display of the computer system, the comparison.

The method of any preceding clause, wherein the at least one user identity selection has categories comprising: Heroes; Intelligences; Talents; and Collections.

The method of any preceding clause, further comprising: receiving, at the computer system from the first user, a Heroes modality selection for the Heroes; receiving, at the computer system from the first user, a Talents modality selection for the Talents; and receiving, at the computer system from the first user, a Collections modality selection for the Collections, wherein the identity ID is further based on the Heroes modality selection, the Talents modality selection, and the Collections modality selection.

The method of any preceding clause, wherein the Talents presented to the first user are determined, at least in part, on selections made by the first user for the Intelligences.

The method of any preceding clause, wherein: the computer system is part of an augmented reality system, such that the user identity of the first user is displayed with an avatar of the first user to others; and avatars of other users within the augmented reality system are accompanied by user identities of the other users.

The method of any preceding clause, wherein: the computer system is part of a virtual reality system, such that the user identity of the first user is displayed with an avatar of the first user to others; and avatars of other users within the virtual reality system are accompanied by user identities of the other users.

The method of any preceding clause, further comprising: weighting, via the at least one processor, the at least one user identity selection based on the ranked order, resulting in at least one weighted identity selection, wherein the identity ID is based on the weighted identity selection.

A system comprising: at least one processor; a display; and a non-transitory computer-readable storage medium having instructions stored which, when executed by the at least one processor, cause the at least one processor to perform operations comprising: assigning to a first user a user identification (ID); receiving, from the first user, at least one user personality selection having a ranked order; generating, for each identity selection within the at least one user identity selection, and identity ID; combining the user ID and the identity ID to form a user identity of the first user; receiving, from the first user, a selection of a second user; comparing the user identity to another identity of the second user, resulting in a comparison; and displaying, via the display, the comparison.

The system of any preceding clause, wherein the at least one user identity selection has categories comprising: Heroes; Intelligences; Talents; and Collections.

The system of any preceding clause, the non-transitory computer-readable storage medium having additional instructions stored which, when executed by the at least one processor, cause the at least one processor to perform operations comprising: receiving, from the first user, a Heroes modality selection for the Heroes; receiving, from the first user, a Talents modality selection for the Talents; and receiving, from the first user, a Collections modality selection for the Collections, wherein the identity ID is further based on the Heroes modality selection, the Talents modality selection, and the Collections modality selection.

The system of any preceding clause, wherein the Talents presented to the first user are determined, at least in part, on selections made by the first user for the Intelligences.

The system of any preceding clause, wherein: the system is part of an augmented reality system, such that the user identity of the first user is displayed with an avatar of the first user to others; and avatars of other users within the augmented reality system are accompanied by user identities of the other users.

The system of any preceding clause, wherein: the system is part of a virtual reality system, such that the user identity of the first user is displayed with an avatar of the first user to others; and avatars of other users within the virtual reality system are accompanied by user identities of the other users.

The system of any preceding clause, the non-transitory computer-readable storage medium having additional instructions stored which, when executed by the at least one processor, cause the at least one processor to perform operations comprising: weighting the at least one user identity selection based on the ranked order, resulting in at least one weighted identity selection, wherein the identity ID is based on the weighted identity selection.

A non-transitory computer-readable storage medium having instructions stored which, when executed by at least one processor, cause the at least one processor to perform operations comprising: assigning to a first user a user identification (ID); receiving, from the first user, at least one user identity selection having a ranked order; generating, for each identity selection within the at least one user identity selection, identity ID; combining the user ID and the identity ID to form a user identity of the first user; receiving, from the first user, a selection of a second user; comparing the user identity to another identity of the second user, resulting in a comparison; and displaying, via the display, the comparison.

The non-transitory computer-readable storage medium of any preceding clause, wherein the at least one user identity selection has categories comprising: Heroes; Intelligences; Talents; and Collections.

The non-transitory computer-readable storage medium of any preceding clause, having additional instructions stored which, when executed by the at least one processor, cause the at least one processor to perform operations comprising: receiving, from the first user, a Heroes modality selection for the Heroes; receiving, from the first user, a Talents modality selection for the Talents; and receiving, from the first user, a Collections modality selection for the Collections, wherein the identity ID is further based on the Heroes modality selection, the Talents modality selection, and the Collections modality selection.

The non-transitory computer-readable storage medium of any preceding clause, wherein the Talents presented to the first user are determined, at least in part, on selections made by the first user for the Intelligences.

The non-transitory computer-readable storage medium of any preceding clause, wherein: the at least one processor is part of an augmented reality system, such that the user identity of the first user is displayed with an avatar of the first user to others; and avatars of other users within the augmented reality system are accompanied by user identities of the other users.

The non-transitory computer-readable storage medium of any preceding clause, wherein: the at least one processor is part of a virtual reality system, such that the user identity of the first user is displayed with an avatar of the first user to others; and avatars of other users within the virtual reality system are accompanied by user identities of the other users.

We claim:

1. A method comprising:
assigning to a first user, via at least one processor of a computer system, a user identification (ID);
receiving, at the computer system from the first user, at least one user identity selection having a ranked order;
generating, via the at least one processor for each personality selection within the at least one user identity selection, and identity ID;
combining, via the at least one processor, the user ID and the identity ID to form a user identity of the first user;
receiving, at the computer system from the first user, a selection of a second user;
comparing, via the at least one processor, the user identity to another identity of the second user, resulting in a comparison; and
displaying, via a display of the computer system, the comparison.

2. The method of claim 1, wherein the at least one user identity selection has categories comprising:
Heroes;
Intelligences;
Talents; and
Collections.

3. The method of claim 2, further comprising:
receiving, at the computer system from the first user, a Heroes modality selection for the Heroes;
receiving, at the computer system from the first user, a Talents modality selection for the Talents; and
receiving, at the computer system from the first user, a Collections modality selection for the Collections,
wherein the identity ID is further based on the Heroes modality selection, the Talents modality selection, and the Collections modality selection.

4. The method of claim 2, wherein the Talents presented to the first user are determined, at least in part, on selections made by the first user for the Intelligences.

5. The method of claim 1, wherein:
the computer system is part of an augmented reality system, such that the user identity of the first user is displayed with an avatar of the first user to others; and
avatars of other users within the augmented reality system are accompanied by user identities of the other users.

6. The method of claim 1, wherein:
the computer system is part of a virtual reality system, such that the user identity of the first user is displayed with an avatar of the first user to others; and
avatars of other users within the virtual reality system are accompanied by user identities of the other users.

7. The method of claim 1, further comprising:
weighting, via the at least one processor, the at least one user identity selection based on the ranked order, resulting in at least one weighted identity selection,
wherein the identity ID is based on the weighted identity selection.

8. A system comprising:
at least one processor;
a display; and
a non-transitory computer-readable storage medium having instructions stored which, when executed by the at least one processor, cause the at least one processor to perform operations comprising:
assigning to a first user a user identification (ID);
receiving, from the first user, at least one user personality selection having a ranked order;
generating, for each identity selection within the at least one user identity selection, and identity ID:
combining the user ID and the identity ID to form a user identity of the first user;
receiving, from the first user, a selection of a second user;
comparing the user identity to another identity of the second user, resulting in a comparison; and
displaying, via the display, the comparison.

9. The system of claim 8, wherein the at least one user identity selection has categories comprising:
Heroes;
Intelligences;
Talents; and
Collections.

10. The system of claim 9, the non-transitory computer-readable storage medium having additional instructions stored which, when executed by the at least one processor, cause the at least one processor to perform operations comprising:
receiving, from the first user, a Heroes modality selection for the Heroes;
receiving, from the first user, a Talents modality selection for the Talents; and
receiving, from the first user, a Collections modality selection for the Collections,
wherein the identity ID is further based on the Heroes modality selection, the Talents modality selection, and the Collections modality selection.

11. The system of claim 9, wherein the Talents presented to the first user are determined, at least in part, on selections made by the first user for the Intelligences.

12. The system of claim 8, wherein:
the system is part of an augmented reality system, such that the user identity of the first user is displayed with an avatar of the first user to others; and
avatars of other users within the augmented reality system are accompanied by user identities of the other users.

13. The system of claim 8, wherein:
the system is part of a virtual reality system, such that the user identity of the first user is displayed with an avatar of the first user to others; and
avatars of other users within the virtual reality system are accompanied by user identities of the other users.

14. The system of claim 8, the non-transitory computer-readable storage medium having additional instructions stored which, when executed by the at least one processor, cause the at least one processor to perform operations comprising:
weighting the at least one user identity selection based on the ranked order, resulting in at least one weighted identity selection,
wherein the identity ID is based on the weighted identity selection.

15. A non-transitory computer-readable storage medium having instructions stored which, when executed by at least one processor, cause the at least one processor to perform operations comprising:
assigning to a first user a user identification (ID);
receiving, from the first user, at least one user identity selection having a ranked order;
generating, for each identity selection within the at least one user identity selection, identity ID;
combining the user ID and the identity ID to form a user identity of the first user;
receiving, from the first user, a selection of a second user;
comparing the user identity to another identity of the second user, resulting in a comparison; and
displaying, via the display, the comparison.

16. The non-transitory computer-readable storage medium of claim 15, wherein the at least one user identity selection has categories comprising:
Heroes;
Intelligences;
Talents; and
Collections.

17. The non-transitory computer-readable storage medium of claim 16, having additional instructions stored which, when executed by the at least one processor, cause the at least one processor to perform operations comprising:
receiving, from the first user, a Heroes modality selection for the Heroes;
receiving, from the first user, a Talents modality selection for the Talents; and
receiving, from the first user, a Collections modality selection for the Collections,
wherein the identity ID is further based on the Heroes modality selection, the Talents modality selection, and the Collections modality selection.

18. The non-transitory computer-readable storage medium of claim 16, wherein the Talents presented to the first user are determined, at least in part, on selections made by the first user for the Intelligences.

19. The non-transitory computer-readable storage medium of claim 15, wherein:
the at least one processor is part of an augmented reality system, such that the user identity of the first user is displayed with an avatar of the first user to others; and
avatars of other users within the augmented reality system are accompanied by user identities of the other users.

20. The non-transitory computer-readable storage medium of claim 15, wherein:
the at least one processor is part of a virtual reality system, such that the user identity of the first user is displayed with an avatar of the first user to others; and
avatars of other users within the virtual reality system are accompanied by user identities of the other users.
